(19) United States
(12) Patent Application Publication
(10) Pub. No.: US 2024/0128644 A1
(43) Pub. Date: Apr. 18, 2024

(54) ANTENNA SYSTEMS

(71) Applicant: Parsec Technologies, Inc., Plano, TX (US)

(72) Inventors: Michael A. Neenan, Plano, TX (US); Richard Loy Smith, JR., Dallas, TX (US); George Alexander Bednekoff, Plano, TX (US); Rauhon Ahmed Shaik, Wylie, TX (US)

(21) Appl. No.: 18/447,210

(22) Filed: Aug. 9, 2023

Related U.S. Application Data
(60) Provisional application No. 63/371,069, filed on Aug. 10, 2022.

(51) Int. Cl. H01Q 5/314; H01Q 9/42

(52) U.S. Cl. CPC H01Q 5/314; H01Q 9/42

(57) ABSTRACT

A multi-band antenna system can include a base, a ground reference portion coupled to the base, and a cover configured to be removably coupled to the base. The antenna system can include one or more of: four low/high multi-band antenna devices, four multi-band WiFi antenna devices, and a GPS radiating device, which can coupled to the ground reference portion and positioned between the base and the cover. The antenna system can be used for mobile and client-based application for wireless telecommunication. When the antenna system is used in conjunction with high order electromagnetic modes generated or received by a transceiver and/or receiver, the antenna system can have an operating frequency range of between about 500 MHz to about 8.0 GHz.

### INCORPORATION BY REFERENCE TO ANY PRIORITY APPLICATIONS

The present application claim priority benefit to U.S. Provisional Application No. 63/371,069, filed Aug. 10, 2022, entitled “ANTENNA SYSTEMS”, which is hereby incorporated herein by reference in its entirety. Any and all applications for which a foreign or domestic priority claim is identified in the Application Data Sheet as filed with the present application are hereby incorporated by reference under 37 CFR 1.57 and made a part of this specification.

### BACKGROUND

### Field

The present disclosure relates to the field of wireless broadband communication, and more particularly to antenna systems and antennas that cover multiple frequency bands used in the telecommunication wireless spectrum.

### Description of the Related Art

Over the last few decades, Long Term Evolution (LTE) has become a standard in wireless data communications technology. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennae that are configured to electromagnetically resonate at frequencies within the dedicated bandwidth. As more wireless devices are used on a frequency bandwidth, a communication bottleneck occurs as wireless devices compete for frequency channels within a dedicated bandwidth. LTE frequency bands range from 450 MHz to 6 GHz, however, antennas configured to resonate within this spectrum only resonate within a portion of the full LTE spectrum. To capture a greater portion of the LTE spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems and which can result in systems with poor functionality and/or coverage.

### SUMMARY

This disclosure relates to antennas that cover multiple frequency bands that are prolific in today's telecommunication wireless spectrum. The advances of telecommunications wireless devices have expanded the number of frequency bands that a radio can support for prolific coverage. For example, there are over 30 LTE Bands that a radio may be asked to support if the radio is to provide ubiquitous coverage for a mobile device. While some of the LTE Bands overlap one another, there are numerous gaps between the bands as well. A multi-band approach to the antenna's frequency response provides a unique and novel radiating structure to support the numerous LTE bands.

According to some advantageous embodiments, a multi-band antenna for mobile and client-based application for the wireless telecommunication marketplace has a feed point, a grounding location, a grounding length, a first portion for low band operation, a second portion for low band operation, and one or more portions for high band operation. The ground reference of the feed point for the multi-band antenna is connected to a separate object that may provide a base for the multi-band antenna. The feed point of the multi-band antenna may be spaced above the base and have a space between the feed point and a location for the ground point and be supported in a PCB based structure. The ground connection has one of more portions before reaching a ground reference some distance away from the feed point. The low band portion has multiple resonances that are often odd multiples of the lowest resonant response. The portions that resonant most dominantly in the high band most often have multiple resonances that are even multiples of the lowest high band resonance. The multi-band antenna preferably has enough resonances spaced closely enough to appear to be a wide band antenna above the fundamental high band resonance.

According to some embodiments, a multi-band antenna comprises a feeding portion, a grounding portion, an upright low band radiation portion, a second low band radiation portion, and a high band radiation portion that is constructed of two arms that are attached to the base of the upright low band radiation portion. According to some embodiments a multi-band antenna system comprises four such low/high multi-band antenna devices, coupled with four multi-band W antenna devices, and a GPS radiating device, on one or more bases, and configured to be protected in use by a suitable cover device, and configured to be attached to a suitable ground plane.

According to some embodiments, a multi-band antenna system can include a base, a ground reference portion coupled to the base, and a cover configured to be removably coupled to the base. The antenna system can include one or more of: four low/high multi-band antenna devices, four multi-band WiFi antenna devices, and a GPS radiating device, which can coupled to the ground reference portion and positioned between the base and the cover. The antenna system can be used for mobile and client-based application for wireless telecommunication. When the antenna system is used in conjunction with high order electromagnetic modes generated or received by a transceiver and/or receiver, the antenna system can have an operating frequency range of between about 500 MHz to about 8.0 GHz.

Some advantageous features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present disclosure in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. Accordingly, the claims should be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 illustrates a perspective view of a multi-element multi-band antenna system on a ground plane enveloped by a non-conductive cover in accordance with some aspects of this disclosure.

FIG. 2 illustrates a perspective view of the multi-element multi-band antenna system of FIG. 1, with the non-conductive cover removed, in accordance with some aspects of this disclosure.

FIG. 3 illustrates a perspective isolation view of PCB portions and/or radiating portions of the multi-element multi-band antenna of FIGS. 1 and 2 showing a detailed view of a grounding portion for a radiating portion in accordance with some aspects of this disclosure.

FIG. 4 illustrates a perspective back side isolation view of the antenna system of FIGS. 1-3 showing coaxial transmission lines and/or feeds and depicting heat relief portions in the ground reference in accordance with some aspects of this disclosure.

FIG. 5A illustrates a top isolation view of the ground reference of the antenna system of FIGS. 1-4, in accordance with some aspects of this disclosure.

FIG. 5B illustrates a bottom isolation view of the ground reference of the antenna system of FIGS. 1-4, in accordance with some aspects of this disclosure.

FIG. 5C illustrates a perspective isolation view of the ground reference and coaxial cables of the antenna system of FIGS. 1-4, in accordance with some aspects of this disclosure.

FIG. 5D illustrates a perspective isolation view of the coaxial cables of the antenna system of FIGS. 1-4, in accordance with some aspects of this disclosure.

FIG. 6 illustrates a perspective view of a multi-element multi-band antenna system on a ground plane enveloped by a non-conductive cover in accordance with some aspects of this disclosure.

FIG. 7 illustrates a perspective view of the multi-element multi-band antenna system of FIG. 6, with the non-conductive cover removed, in accordance with some aspects of this disclosure.

FIG. 8 illustrates a perspective isolation view of PCB portions and/or radiating portions of the multi-element multi-band antenna of FIGS. 6 and 7 showing a detailed view of a grounding portion for a radiating portion in accordance with some aspects of this disclosure.

FIG. 9 illustrates a perspective back side isolation view of the antenna system of FIGS. 6-8 showing coaxial transmission line feeds and depicting heat relief portions in the ground reference in accordance with some aspects of this disclosure.

FIG. 10A illustrates a top isolation view of the ground reference of the antenna system of FIGS. 6-9, in accordance with some aspects of this disclosure.

FIG. 10B illustrates a bottom isolation view of the ground reference of the antenna system of FIGS. 6-9, in accordance with some aspects of this disclosure.

FIG. 10C illustrates a perspective isolation view of the ground reference and coaxial cables of the antenna system of FIGS. 6-9, in accordance with some aspects of this disclosure.

FIG. 10D illustrates a perspective isolation view of the coaxial cables of the antenna system of FIGS. 6-9, in accordance with some aspects of this disclosure.

FIG. 11 illustrates a perspective view of an antenna system that include eight of the multi-element multi-band antenna of FIGS. 6-10D arranged in an array on a client ground plane, in accordance with some aspects of this disclosure.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION

Illustrative implementations of the preferred embodiments are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The system and method in accordance with the present disclosure overcomes problems commonly associated with traditional antenna systems. In particular, the system of the present application discloses an antenna system having a multi-band antenna comprising a feeding portion, a grounding portion, an upright low band radiation portion, a second low band radiation portion, and a high band radiation portion that is constructed of two arms that are attached to the base of the upright low band radiation portion. In another example, the system of the present application discloses an antenna system having a multi-band antenna comprising two such low/high multi-band antenna devices, coupled with three multi-band WiFi antenna devices, and a GPS radiating device, on one or more bases, and configured to be protected in use by a suitable cover device, and configured to be attached to a suitable ground plane. In yet another example, the system of the present application discloses an antenna system having a multi-band antenna comprising four such low/high multi-band antenna devices, coupled with four multi-band WiFi antenna devices, and a GPS radiating device, on one or more bases, and configured to be protected in use by a suitable cover device, and configured to be attached to a suitable ground plane. These and other unique features of the system are discussed below and illustrated in the accompanying drawings.

The system and method will be understood, both as to its structure and operation, from the accompanying drawings, taken in conjunction with the accompanying description. Several implementations of the system may be presented herein. It should be understood that various components, parts, and features of the different implementations may be combined together and/or interchanged with one another, all of which are within the scope of the present application, even though not all variations and particular implementations are shown in the drawings. It should also be understood that the mixing and matching of features, elements, and/or functions between various implementations is expressly contemplated herein so that one of ordinary skill in the art would appreciate from this disclosure that the features, elements, and/or functions of one implementation may be incorporated into another implementation as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary implementation, however, alternate implementations having scaled and proportional dimensions of the presented exemplary implementation are also considered. Additional features and functions are illustrated and discussed below.

### Single Structure Multi-Element Multi-Band Antenna

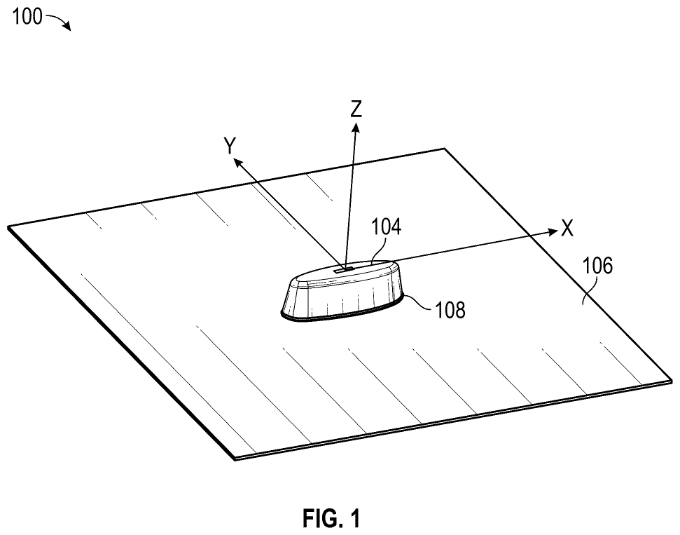

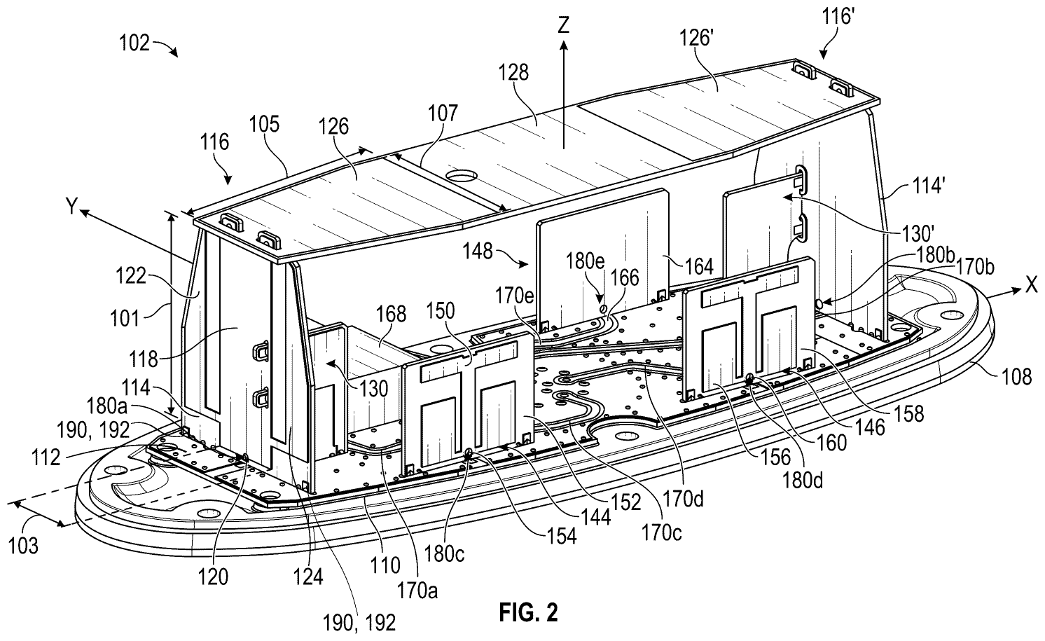

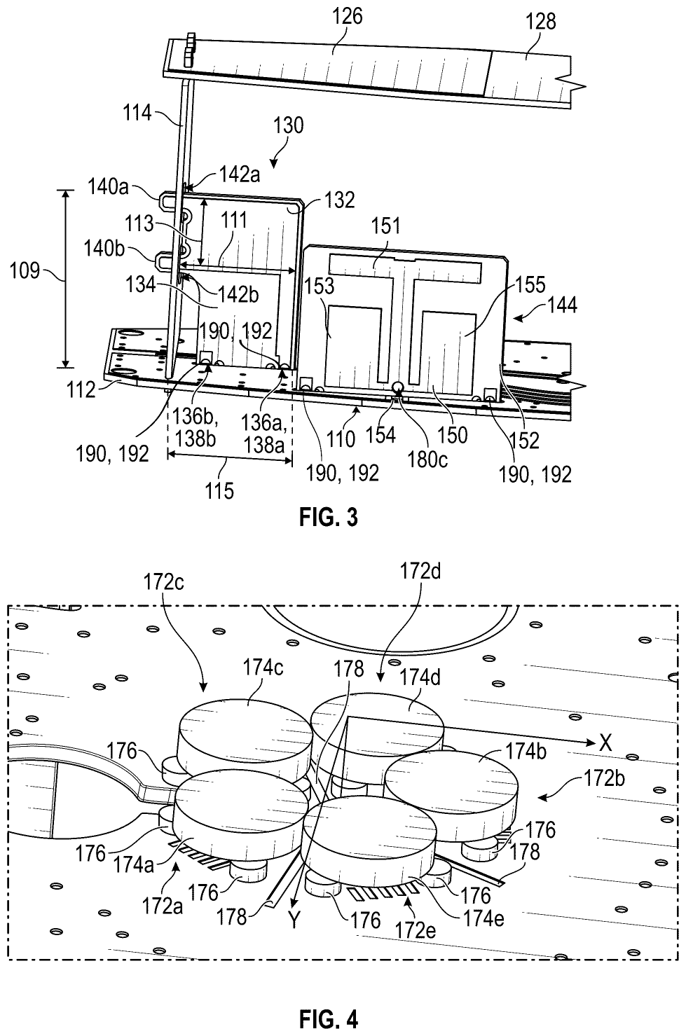

Referring now to the drawings wherein like reference characters identify corresponding or similar elements in form and function throughout the several views. FIGS. 1 and 2 illustrate top perspective views of an antenna assembly that can include a multi-element multi-band antenna on a ground plane showing the system with and without being enveloped by a non-conductive cover. FIGS. 3-5D illustrate assorted views of the multi-element multi-band antenna of FIGS. 1 and 2 showing isolation views of various components that may be included in the antenna assembly, according to some embodiments.

According to some embodiments, features, and aspects of this disclosure, a multi-element multi-band antenna system, when used in conjunction with high order electromagnetic modes generated or received by a transceiver and/or receiver, permit the multi-element multi-band antenna system to have an operating frequency range of between about 500 MHz to about 8.0 GHz. According to some embodiments, a multi-band antenna for mobile and client-based application for the wireless telecommunication marketplace has a feed point, a grounding location, a grounding length, a first portion for low band operation, a second portion for low band operation, and one or more portions for high band operation. The ground reference of the feed point for the multi-band antenna is connected to a separate object that may provide a base for the multi-band antenna. The feed point of the multi-band antenna may be spaced above the base and have a space between the feed point and a location for the ground point and be supported in a PCB based structure. The ground connection has one of more portions before reaching a ground reference some distance away from the feed point. The low band portion has multiple resonances that are often odd multiples of the lowest resonant response. The portions that resonant most dominantly in the high band most often have multiple resonances that are even multiples of the lowest high band resonance. The multi-band antenna preferably has enough resonances spaced closely enough to appear to be a wide band antenna above the fundamental high band resonance.

In accordance with some aspects of this disclosure, a multi-band antenna comprises a feeding portion, a grounding portion, an upright low band radiation portion, a second low band radiation portion, and a high band radiation portion that is constructed of two arms that are attached to the base of the upright low band radiation portion. According to some implementations a multi-band antenna system comprises two such low/high multi-band antenna devices, coupled with three multi-band WiFi antenna devices, and a GPS radiating device, on one or more bases, and configured to be protected in use by a suitable cover device, and configured to be attached to a suitable ground plane. In some implementations, the ground reference portion of the base preferably comprises five coaxial inputs that are coupled to the microstrip transmission lines that are embedded in the ground reference portion. In some implementations, there are one or more reliefs in the ground reference portion having a size, orientation, and shape that are preferably configured such that the conduction of the heat during the soldering process of the coaxial connectors is inhibited in its flow into the expanse of the ground reference portion and the other coaxial connectors. According to some implementations, the heat flow preferably encounters significant thermal resistance while the microwave energy moving along the microstrip transmission lines embedded in the ground reference portion is not disturbed.

According to some implementations, the upright low band radiation portion has a second portion that is coplanar to the first portion and a high band radiation portion that is constructed of two arms that are attached to the base of the upright low band radiation portion. In some implementations, the upright low band radiation portion has a second portion that is coplanar to the first portion and a high band radiation portion that is constructed of a single arm that attached to the base of the upright low band radiation portion. In some implementations, the upright low band radiation portion has a second portion that is not-coplanar to the first portion and a high band radiation portion that is constructed of a two arms that are attached to the base of the upright low band radiation portion. In some implementations, the upright low band radiation portion has a second portion that is not-coplanar to the first portion and a high band radiation portion that is constructed of a single arm that is attached to the base of the upright low band radiation portion. In some implementations, the upright low band radiation portion has a second portion that is coplanar to the first portion and a high band radiation portion that is constructed of a plurality of arms that are attached to the base of the upright low band radiation portion. In some implementations, the upright low band radiation portion has a second portion that is not-coplanar to the first portion and a high band radiation portion that is constructed of a plurality of arms that attached to the base of the upright low band radiation portion. In some implementations, the upright low band radiation portion has a second portion that is coplanar to the first portion and a high band radiation portion that is constructed of a plurality of arms of different lengths that are attached to the base of the upright low band radiation portion. In some implementations, the upright low band radiation portion has a second portion that is not-coplanar to the first portion and a high band radiation portion that is constructed of a plurality of arms of different lengths that attached to the base of the upright low band radiation portion.

According to some implementations, a multi-band antenna, comprises a feeding portion, a grounding portion, an upright low band radiation portion, a second low band radiation portion, a third low band radiation portion of one length coupled to the second low band radiation portion, and a high band radiation portion that is constructed of two arms that are attached to the base of the upright low band radiation portion.

According to some implementations, the upright low band radiation portion has a second portion that is coplanar to the first portion and a high band radiation portion that is constructed of two arms that are attached to the base of the upright low band radiation portion. According to some implementations, the upright low band radiation portion has a second portion that is coplanar to the first portion and a high band radiation portion that is constructed of a single arm that is attached to the base of the upright low band radiation portion. According to some implementations, the upright low band radiation portion has a second portion that is not-coplanar to the first portion and a high band radiation portion that is constructed of a two arms that are attached to the base of the upright low band radiation portion. According to some implementations, the upright low band radiation portion has a second portion that is not-coplanar to the first portion and a high band radiation portion that is constructed of a single arm that is attached to the base of the upright low band radiation portion. According to some implementations, the upright low band radiation portion has a second portion that is coplanar to the first portion and a high band radiation portion that is constructed of a plurality of arms that are attached to the base of the upright low band radiation portion. According to some implementations, the upright low band radiation portion has a second portion that is not-coplanar to the first portion and a high band radiation portion that is constructed of a plurality of arms that are attached to the base of the upright low band radiation portion. According to some implementations, the upright low band radiation portion has a second portion that is coplanar to the first portion and a high band radiation portion that is constructed of a plurality of arms of different lengths that are attached to the base of the upright low band radiation portion. According to some implementations, the upright low band radiation portion has a second portion that is not-coplanar to the first portion and a high band radiation portion that is constructed of a plurality of arms of different lengths that are attached to the base of the upright low band radiation portion.

According to some implementations, a multi-band antenna comprises a feeding portion, a grounding portion, an upright low band radiation portion, a second low band radiation portion, a third low band radiation portion of one length coupled to the second low band radiation portion, a fourth low band radiation portion of a length different to the third low band radiation portion while coupled to the second low band radiation portion while also coupled to the third low band radiation portion, and a high band radiation portion that is constructed of two arms that are attached to the base of the upright low band radiation portion.

According to some implementations, the upright low band radiation portion has a second portion that is coplanar to the first portion and a high band radiation portion that is constructed of two arms that are attached to the base of the upright low band radiation portion. According to some implementations, the upright low band radiation portion has a second portion that is coplanar to the first portion and a high band radiation portion that is constructed of a single arm that is attached to the base of the upright low band radiation portion. According to some implementations, the upright low band radiation portion has a second portion that is not-coplanar to the first portion and a high band radiation portion that is constructed of two arms that attached to the base of the upright low band radiation portion. According to some implementations, the upright low band radiation portion has a second portion that is not-coplanar to the first portion and a high band radiation portion that is constructed of a single arm that attached to the base of the upright low band radiation portion. According to some implementations, the upright low band radiation portion has a second portion that is coplanar to the first portion and a high band radiation portion that is constructed of a plurality of arms that are attached to the base of the upright low band radiation portion. According to some implementations, the upright low band radiation portion has a second portion that is not-coplanar to the first portion and a high band radiation portion that is constructed of a plurality of arms that are attached to the base of the upright low band radiation portion. According to some implementations, the upright low band radiation portion has a second portion that is coplanar to the first portion and a high band radiation portion that is constructed of a plurality of arms of different lengths that are attached to the base of the upright low band radiation portion. According to some implementations, the upright low band radiation portion has a second portion that is not-coplanar to the first portion and a high band radiation portion that is constructed of a plurality of arms of different lengths that are attached to the base of the upright low band radiation portion.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

With reference to FIG. 1, a perspective view of an antenna assembly 100 is illustrated in accordance with an implementation of the present disclosure. The antenna assembly 100 may include a multi-element multi-band antenna 102. The multi-element multi-band antenna 102 may be configured to provide wireless internet connectivity for a plurality of uses (e.g., data, voice communication, and/or the like). The multi-element multi-band antenna 102 may have particular benefits when used in places such as kiosks, vehicles, portable wireless access points, and/or the like, however, the multi-element multi-band antenna 102 may be used in a wide range of applications. The multi-element multi-band antenna 102 may have a smaller volume and profile when compared to other antenna systems. For example, antenna assembly 100 may have a cubic volume of approximately 18 cubic inches.

In some implementations, the antenna assembly 100 may be mounted on a client ground plane 106, as shown in FIG. 1. The components of the multi-element multi-band antenna 102 may be concealed and/or secured within and/or between a radome 104 (also referred to herein as “cover” 104 and “non-conducive cover” 104) and a support base 108 (also referred to herein as “base” 108). For ease of reference, a consistent coordinate system (X, Y, and Z) is included in the majority of the Figures herein, either outside of the drawings or embedded within the drawings. In some implementations, the antenna assembly 100 can have an IP67 rating.

As shown in FIGS. 1-4, the multi-element multi-band antenna 102 may include one or more of the following components: a base PCB portion 112, an internal ground plane 110, a first radiating portion 116, a second radiating portion 116′, a grounding portion 130, a second grounding portion 130′, a third radiating portion 144, a fourth radiating portion 146, a fifth radiating portion 148, a GPS radiating portion 168, a plurality of microstrip transmission lines 170, and a plurality of coaxial cables 172. In some implementations, a plurality of fasteners can be used to secure the components of the antenna assembly 100 together and can include fasteners, magnets, and/or the like. These components and other components that may be included in the antenna assembly 100 are described herein with reference to FIGS. 1-4. The multi-element multi-band antenna 102 may have an operating frequency range of 500 MHz to 8.0 GHz. In some cases, the multi-element multi-band antenna 102 can have optimal performance when operating at a frequency range of 600 MHz to 6.0 GHz.

The client ground plane 106 may be in the form of conducting surfaces on vehicles, buildings, indoor or outdoor equipment enclosures, and other such customer premise equipment. Those skilled in the art would understand that the nature of the deployment of such the antenna assembly 100 will change slightly in the deployed performance based on type of structure the antenna assembly 100 is attached to as well as the surroundings in which it is deployed. Those skilled in the art realize that the lower frequency bands of the multi-element multi-band antenna 102 may work best when placed on a ground plane, such as the client ground plane 106, but that a ground plane is not required for applications where a reduction in the level of performance of the antenna assembly 100 is acceptable. Accordingly, in some implementations, the client ground plane 106 is not required and does not form a portion of the antenna assembly 100.

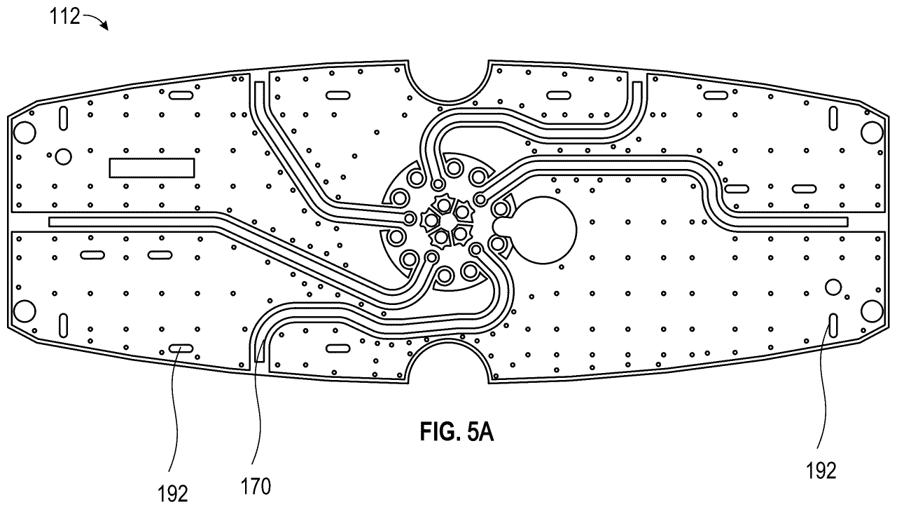

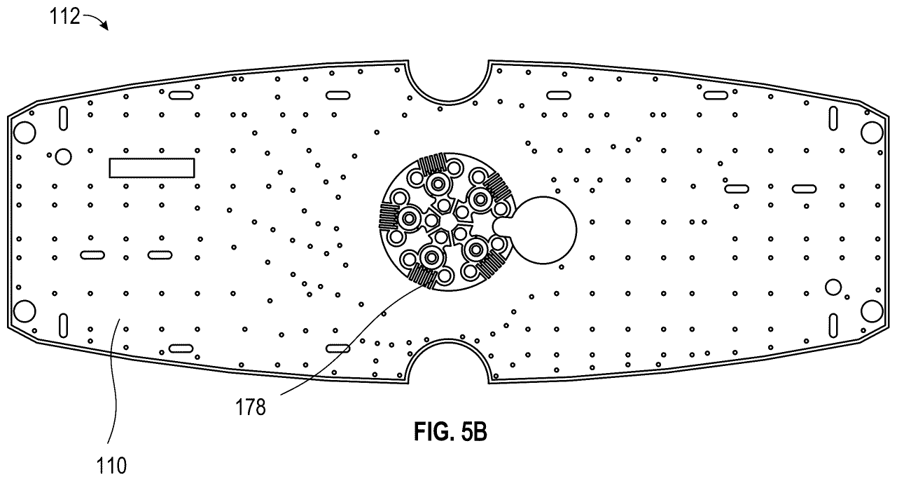

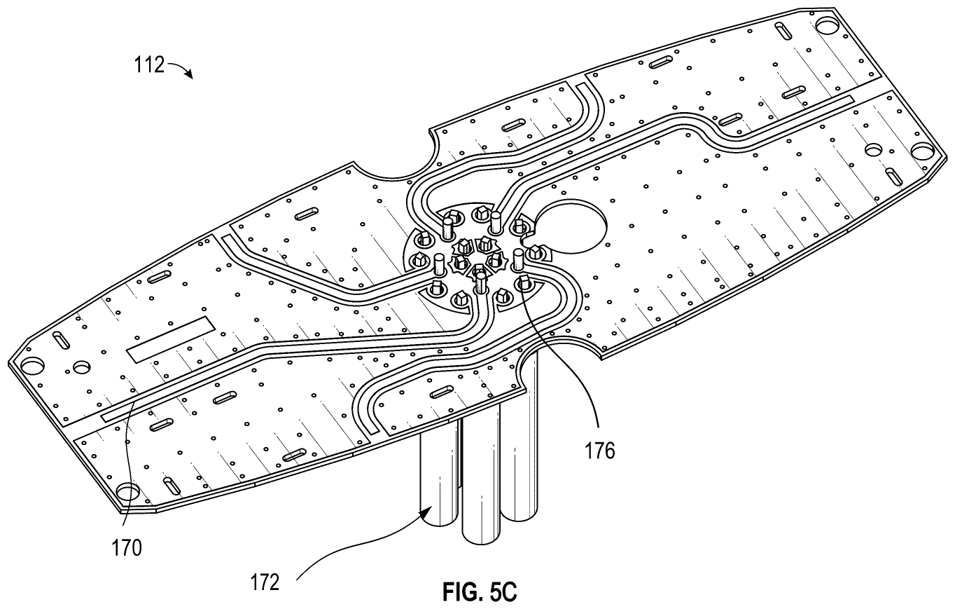

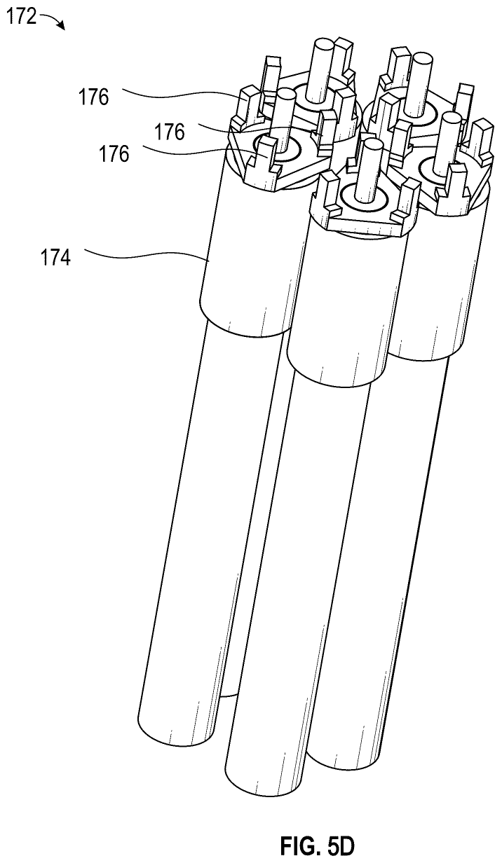

In some operating cases, when the antenna assembly 100 is not mounted to the client ground plane 106 (e.g., when the antenna assembly 100 is mounted to a non-conductive surface), the multi-element multi-band antenna 102 may use a portion of the coaxial cables 172 (see e.g., FIG. 4) to serve as a ground plane for at least a portion of the multi-element multi-band antenna 102. For example, as discussed with reference to FIG. 4, the coaxial cables can each include a center conductor (see FIGS. 5C and 5D) and an outer conductor 174. In some implementations the outer conductors 174 of the coaxial cables 172 that feed the multi-element multi-band antenna 102 can serve as a ground plane for the antenna assembly 100.

The radome 104 may protect and/or provide mechanical support for the multi-element multi-band antenna 102. For example, the multi-element multi-band antenna 102 can be enveloped by the radome 104. The radome 104 may be transparent to radiation from the multi-element multi-band antenna 102 and may serve as an environmental shield for the internal components of the multi-element multi-band antenna 102. The radome 104 may be made of a non-conductive material. The radome 104 may be generally rectangular prism shaped, with an open bottom. In some implementations, the radome 104 can include curved front and back ends. Other suitable shapes can be used for the radome 104. The radome 104 can be configured to be removably coupled to the base 108. In some cases, the shape of the radome 104 can be selected based on the expected operating conditions for the antenna assembly 100. For example, the expected wind-load on the antenna assembly 100 when in use (e.g., when mounted to a vehicle) can impact the design of the radome 104. In the illustrated example, the radome 104 is designed to minimize the amount of drag provided by the antenna assembly 100 when in use, while still providing enough room for the internal antenna components described herein. For example, the narrow profile of the radome 104 can provide the antenna assembly 100 with a lower aerodynamic profile compared to an antenna assembly with a broad profile.

The support base 108 forms the base of the antenna assembly 100. The supports base 108 provides mechanical support for the multi-element multi-band antenna 102. The support base 108 can be electrically conductive (e.g., be made of a conductive material such as a metal), although this is not required. Having a conductive support base 108 for the multi-element multi-band antenna 102 may provide certain advantages, such as providing an electrical connection between an internal ground plane 110 (e.g., see FIG. 2), which can be positioned on the support base 108 in the assembled configuration, and the client ground plane 106. In some implementations, the support base 108 includes a plurality of small gaps (not shown) in the surface of the support base 108, which may facilitate the use of non-conductive weather resistant material. In some implementations, the size and proximity of the support base 108 may be selected to provide an electromagnetic connection between the client ground plane 106 and the internal ground plane 110. The combination of at least the non-conductive radome 104 and the conductive support base 108 provide mechanical and environmental protection for the multi-element multi-band antenna 102 as well as grounding for the electrically active, radiating, portions internal to the antenna assembly 100. In some implementations, the support base 108 can include magnets positioned within the support base 108 to allow the antenna assembly 100 to be magnetically coupled to external surfaces.

As shown in FIG. 1, the radome 104 can be positioned on the support base 108 to secure the internal components of the antenna assembly 100, including the multi-element multi-band antenna 102. The radome 104 may include a plurality of fastener holes which may extend up the side walls of the radome 104. In some implementations, the fastener holes may be tapered. In some implementations, the fastener holes may be threaded. These plurality of fastener holes may be aligned with fastener holes of the support base 108 in the assembled configuration, and fasteners can be positioned within the holes to secure the radome 104 and the internal components of the multi-element multi-band antenna 102 to the support base 108. In some cases, the fasteners can serve a dual purpose of fastening the base PCB portion 112 to the support base 108 as well as providing a ground connection between the base PCB portion 112 and the support base 108. As such, the height of the fasteners relative to the base PCB portion 112 (e.g., the extension into the radome 104) can be selected to minimize the interference provided by the fasteners. In some implementations, the support base 108 can include a base slot. Either or both of fastener holes and the base slot may assist with mechanically coupling the support base 108 to the radome 104. For example, a bottom edge of the radome 104 can be received within the base slot of the support base 108 when the multi-element multi-band antenna 102 is in the assembled configuration. In some implementations, the assembled antenna assembly 100 may have an approximate length of six inches, an approximate width of two inches, and an approximate height of one and a half inches. This small profile, particularly the small width and height can significantly improve the aerodynamic properties of the antenna assembly 100 when in operation.

FIG. 2 illustrates a perspective view of the antenna assembly 100 of FIG. 1 with the radome 104 removed to further illustrate the internal component of the multi-element multi-band antenna 102. The multi-element multi-band antenna 102 can include the internal ground plane 110, a plurality of printed circuit board “PCB” portions (e.g., including at least a base PCB portion 112 and one or more upright portions, such as a first upright PCB portion 114), and at least one radiation portion (e.g., a first radiating portion 116). In some implementations, the multi-element multi-band antenna 102 can include a second radiating portion 116′, as described herein. In some implementations, the multi-element multi-band antenna 102 can include one or more additional radiating portions (e.g., a third radiating portion 144, a fourth radiating portion 146, and/or a fifth radiating portion 148) as described herein.

Removing the radome 104 also removes all the fasteners to releasably connect the cover 104, the internal ground plane 110 and the support base 108. There are a number of suitable ways to connect the major portions of antenna assembly 100. In some implementations, the internal ground plane 110 is coupled (e.g., mechanical fastened) to the support base 108 separately from the radome 104. This arrangement may provide a benefit of allowing the radome 104 to be independently coupled to the support base 108 (e.g., removing the radome 104 from the support base 108 will not cause the internal ground plane 110 to be separated from the support base 108).

The internal ground plane 110 (also referred to herein as the ground reference 110), shown in FIG. 4, may serve as the ground reference for at least one or more of the radiating portions described herein (e.g., the first radiating portion 116, the second radiating portion 116′, the third radiating portion 144, the fourth radiating portion 146, and/or the fifth radiating portion 148) and the plurality of microstrip transmission lines 170. The internal ground plane 110 is configured to be housed within the multi-element multi-band antenna 102 (e.g., between the radome 104 and the support base 108). The internal ground plane 110 can either be formed on the bottom side of the base PCB portion 112 or may be a separate component from the base PCB portion 112. For example, the internal ground plane 110 can be a solderable sheet metal material such as brass, copper, tin plated steel, and/or the like. In some implementations, the internal ground plane 110 may be formed on the bottom side of the base PCB portion 112. For example, the internal ground plane 110 may be a conductive surface (e.g., brass, copper, tin plated steel, and/or the like) formed on the bottom side of the base PCB portion 112. The internal ground plane 110 may serve as a reference point for operation of the multi-element multi-band antenna 102. The internal ground plane 110 can establish a surface for the coaxial cables 172 to use as a reference for continuation of the signal from the radio to the radiating elements.

As described herein, the multi-element multi-band antenna 102 can include one or more PCB portions (e.g., the base PCB portion 112, the first upright PCB portion 114, etc.) The PCB portions may be made of flexible substrate materials (e.g., polyimide). As such, the PCB portions may be a flex circuit. In some cases, the PCB portions may be fiberglass reinforced with epoxy (e.g., FR4). The PCB portions may provide structure for the radiating portions of the multi-element multi-band antenna 102. For example, the various conductive portions of the radiating portions may be etched into the structure of the PCB portions.

With continued reference to FIG. 2, the multi-element multi-band antenna 102 can include a first radiating portion 116. Depending on the configuration, the first radiating portion 116 can be configured for low band, mid band, and/or high band operations. The first radiating portion 116 can also be referred to herein as the first radiating structure 116 and/or the first radiating element 116, because the first radiating portion 116 can include a plurality of different radiating portions, each configured for operation at different frequency ranges/bands. However, for ease of reference, the various radiating portions/radiating elements of the first radiating portion 116 will be referred to herein as individual “conductive portions”. It is recognized that each conductive portion can be an individual radiating portion/element, having its own band of operation.

The first radiating portion 116 can include an upright conductive portion 118. The term “upright”, as used herein generally refers to elements of the multi-element multi-band antenna 102 that are substantially vertical in relation to the ground reference 110. For example, the upright elements can be perpendicular to the internal ground plane 110 (e.g., at an angle relative to the internal ground plane 110 between 85-degrees and 95-degrees). The first radiating portion 116 can be supported at least in part by the first upright PCB portion 114. The first radiating portion 116 can be electrically coupled to the internal ground plane 110. For example, the first upright PCB portion 114 can be coupled to the base PCB portion 112. The first upright PCB portion 114 can be generally perpendicular relative to the base PCB portion 112. For example, the first upright PCB portion 114 may extend from the base PCB portion 112 at approximately a 90-degree angle (e.g., between 85-degrees and 95-degrees). In other implementations, different angles are possible. The first radiating portion 116 can be used for communication between approximately 500 MHz and 8 GHz. For example, the first radiating portion 116 may be able to operate at low bands, mid bands, and high bands. In other implementations, different frequency ranges are possible. The first radiating portion 116 may be/function as a monopole antenna.

The upright conductive portion 118 can be generally rectangularly shaped. Other shapes are also possible for the first upright conductive portion 118. In one example, the upright conductive portion 118 could include a tapered or V-shaped bottom portion. The upright conductive portion 118 can be formed on the first upright PCB portion 114. The upright conductive portion 118 can be configured for low band operation (e.g., communications less than approximately 1 GHz). The upright conductive portion 118 can have a height 101 and a width 103, which can impact the low band operation of the upright conductive portion 118, as described herein. The first upright conductive portion 118 can be coupled to a feeding portion 120 at the base of the upright conductive portion 118. The feeding portion 120 is used to electrically exited the first radiating portion 116. In some cases, the width 103 can range between 0.03 inches and 3 inches. However, the width 103 can be selected based on the desired operation of the multi-element multi-band antenna 102 and desired profile of the radome 104, and other sizes are possible. The location and starting point of the upright conductive portion 118 on the first upright PCB portion 114 relative to the base PCB portion 112 can be adjusted to change the overall performance of the multi-element multi-band antenna 102. For example, changing the position of the upright conductive portion 118 changes the distance to the internal ground plane 110. In some cases, changing the position changes the impedance match for each of the different higher order modes that can be served by the combine influence of the conductive arm portions 122, 124 described below. As such, the location of the first upright PCB portion 114 can be selected based on the selected compromise of all the higher order modes.

In some implementations, the first radiating portion 116 can include only the upright conductive portion 118. In other implementations, including the implementation illustrated in FIG. 2, the first radiating portion 116 can include one or more additional conductive portions, such as a first conductive arm portion 122 and/or a second conductive arm portion 124. The conductive arm portions 122, 124 can be formed on the first upright PCB portion 114. As such, the conductive arm portions 122, 124 can be coplanar to the upright conductive portion 118. The conductive arm portions 122, 124 can be coupled to the upright conductive portion 118. For example, the conductive arm portions 122, 124 can be coupled to the upright conductive portion 118 near its base. The conductive arm portions 122, 124 may extend horizontally from the upright conductive portion 118 and then vertically along the edges of the first upright PCB portion 114. There can be a gap (e.g., a portion of the first upright PCB portion 114 not including conductive material) between the vertical portions of the conductive arm portions 122, 124 and the upright conductive portion 118. In some implementations, the conductive arm portions 122, 124 can have chamfered edges. For example, the conductive arm portions 122, 124 can include a rectangular base portion and a triangular top portion. The triangular top portion can be used to taper the conductive arm portions 122, 124 such that the front and back ends of the radome 204 can be similarly tapered or curved, which can improve the aerodynamic profile of the antenna assembly 100, as described herein. In some implementations, the shape of the conductive arm portions 122, 124 are defined by the shape of the first upright PCB portion 114. The conductive arm portions 122, 124 can be configured for high band operation. For example, the conductive arm portions 122, 124 may improve the high band operation of the first radiating portion 116. The conductive arm portions 122, 124 may assist with the dominate radiation in the high band from the multi-element multi-band antenna 102. Higher even order resonances may radiate from the conductive arm portions 122, 124 of the first radiating portion 116 to assist in the multi-band properties of the multi-element multi-band antenna 102. Having the conductive arm portions 122, 124 on the same feeding portion 120 as the upright conductive portion 118 (e.g., in a coplanar arrangement) can provide certain benefits. For example, the overall length of the antenna assembly 100 can be reduced. Additionally, the distance between the first radiating portion 116 and the second radiating portion 116′, described herein, can be reduced, which also reduces the overall length of the antenna assembly 100.

While FIG. 2 illustrates two conductive arm portions 122, 124, it is recognized that the first radiating portion 116 can include more or less conductive arm portions. In one example, the first radiating portion 116 includes only one conductive arm portion (e.g., either conductive arm portion 122 or conductive arm portion 124). In another example, the first radiating portion 116 can include a plurality of conductive arm portions similar to the conductive arm portions 122, 124. For example, the first radiating portion 116 can include more than two, more than three, more than four, more than six, more than eight, more than ten, and/or the like conductive arm portions.

Similarly, while FIG. 2 illustrates two conductive arm portions 122, 124 that are the same size, this is not a requirement. For example, the conductive arm portion 122 can be a different size and/or shape than the conductive arm portion 124. When the first radiating portion 116 includes a plurality of conductive arm portions, the plurality of conductive arm portions can be the same size and/or shape or have varying sizes and/or shape. Further, the conductive arm portions (either the two conductive arm portions 122, 124, a single conductive arm portion 122, or a plurality of conductive arm portions) may not be coplanar with the upright conductive portion 118. In some examples, the various conductive arm portions can be not-coplanar with the upright conductive portion 118.

According to some implementations, including the implementation illustrated in FIG. 2, the first radiating portion 116 may include a head conductive portion 126. However, it is recognized that the head conductive portion 126 is not required and some implementations of the first radiating portion 116 do not include the head conductive portion 126. The head conductive portion 126 may be coupled to the upright conductive portion 118. The head conductive portion 126 can be formed on a top PCB portion 128. The head conductive portion 126 can have a length 105 and a maximum width 107. The combined total length of the low band conductive portions (e.g., the combined height 101 of the upright conductive portion 118 and the length 105 of the head conductive portion 126) can determine the lowest frequency of operation. In some cases, the balance of the height 101 of the upright conductive portion 118 and the length 105 of the head conductive portion 126 can determine the impedance match of the higher order modes. Generally, the length 105 and maximum width 107 of the head conductive portion 126 can be determined by desired operating range and shape requirements for the radome 104, as described herein. In some cases, length 105 and maximum width 107 of the head conductive portion 126 can be balanced along with the geometry of the grounding portion 130 described herein to optimize the overall impedance match and antenna pattern performance. In some cases, the maximum width 107 can range between 0.03 inches and 3 inches. However, the maximum width 107 can be selected based on the desired operation of the multi-element multi-band antenna 102 and the desired profile of the radome 104, and other sizes are possible.

The top PCB portion 128 can be supported by and/or extend from the top of the first upright PCB portion 114. The top PCB portion 128 can be perpendicular to the first upright PCB portion 114, such that the top PCB portion 128 extends at approximately a 90-degree angle (e.g., between 85-degrees and 95-degrees) from the first upright PCB portion 114. In other implementations, different angles are possible. As such, the first radiating portion 116 can be three-dimensional. In some implementations, the top PCB portion 128 can be cantilevered from the first upright PCB portion 114. In other implementations, the top PCB portion 128 can be supported by a second upright PCB portion 114′, described herein. In some implementations, the head conductive portion 126 can operate in the same frequency range as the upright conductive portion 118. For example, both the upright conductive portion 118 and the head conductive portion 126 can be configured for low band operation. By including two distinctive portions in the first radiating portion 116 that operate at the same frequency range (e.g., the upright conductive portion 118 and the head conductive portion 126), the overall height of the first radiating portion 116 can be reduced. For example, because the head conductive portion 126 extends horizontally. Having a three-dimensional first radiating portion 116 can also reduce the total height and/or total volume of the antenna assembly 100, which can be desirable. For example, having a three-dimensional first radiating portion 116 can reduce the overall size of the antenna assembly 100 when compared to a two-dimensional antenna, while still maintaining the effectiveness of the multi-element multi-band antenna 102. In some cases, it is desirable to make the multi-element multi-band antenna 102 as compact as possible to conserve space. Having a three-dimensional first radiating portion 116 can help reduce the overall size of the multi-element multi-band antenna 102, which is desirable in some use cases, particularly when it is not desirable to see the antenna assembly 100. In another example, having two distinct radiating portions can reduce the total height of the multi-element multi-band antenna 102 to be more compact and conserve space, and allows the multi-element multi-band antenna 102 to be configured to be able to easily cover and provide protection for the antenna assembly 100 in a compact configuration with multi-band coverage.

Various method of supporting the top PCB portion 128 via the first upright PCB portion 114 can be used. In one example, the first upright PCB portion 114 can include one or more projections on its top end. The one or more projections can extend through one or more slots or holes in the top PCB portion 128, which can be used to couple the first upright PCB portion 114 and the top PCB portion 128. In another example, the first upright PCB portion 114 and the top PCB portion 128 may be formed from a single PCB portion with a bend.

In some implementations, the head conductive portion 126 may extend along the first upright PCB portion 114. For example, the head conductive portion 126 may be coplanar to the upright conductive portion 118 such that the first radiating portion 116 includes two distinct conductive portions in the same plane. This arrangement may increase the overall height of the first upright PCB portion 114, the multi-element multi-band antenna 102, and/or the antenna assembly 100. Having purely vertical conductive portions for the first radiating portion 116 (e.g., where the upright conductive portion 118 is coplanar to the head conductive portion 126) can simplify the assembly of the multi-element multi-band antenna 102 and may be desirable when the when the size/height of the multi-element multi-band antenna 102 is not an important design consideration. However, including the head conductive portion 126 that extends at an angle relative to the first upright PCB portion 114 can provide a benefit of reducing the overall size of the multi-element multi-band antenna 102, which can be desirable, as described herein.

In some implementations, the first radiating portion 116 can include additional conductive portions configured for low band operation in addition to the upright conductive portion 118 and the head conductive portion 126. For example, the first radiating portion 116 can include a third conductive portion configured for low band operation. The third conductive portion can be coupled to the head conductive portion 126 and/or the upright conductive portion 118. In yet another example, the first radiating portion 116 can include a fourth conductive portion configured for low band operation. The fourth conductive portion can be coupled to the third conductive portion, the head conductive portion 126, and/or the upright conductive portion 118. In some examples, the third conductive portion and the fourth conductive portion can have the same length. In other examples, the third conductive portion and the fourth conductive portion can have different lengths.

In some implementations, including the implementation illustrated, the multi-element multi-band antenna 102 can include a second radiating portion 116′ formed on a second upright PCB portion 114′. The second radiating portion 116′ and the second upright PCB portion 114′ can be identical to the first radiating portion 116 and the first upright PCB portion 114 respectively and can include all the same components of the first radiating portion 116 and the first upright PCB portion 114 described herein (e.g., referred to with a “prime” symbol herein). It is recognized that the second radiating portion 116′ can include all the variations described herein with reference to the first radiating portion 116.

The second radiating portion 116′ can be positioned on an opposite end of the first radiating portion 116. For example, the first radiating portion 116 and the second radiating portion 116′ can be linearly spaced on the base PCB portion 112. The top PCB portion 128 can extend between the first upright PCB portion 114 and the second upright PCB portion 114′. In the illustrated example, the head conductive portion 126 of the first radiating portion 116 is coplanar with the head conductive portion 126′ of the second radiating portion 116′. However, this is not required. In an example, where the top PCB portion 128 is cantilevered on the first upright PCB portion 114, the head conductive portion 126′ of the second radiating portion 116′ may be formed on a separate PCB portion (e.g., a second top PCB portion 128′) cantilevered on the second upright PCB portion 114′. In this example, the head conductive portion 126 and the head conductive portion 126′ are optionally not-coplanar (e.g., the top PCB portions 128, 128′ can extend at non-90-degree angles relative to their upright PCB portions 114, 114′). By including both the first radiating portion 116 and the second radiating portion 116′, the multi-element multi-band antenna 102 can allow for two cellular antennas for two unique transmit/receive radios to operate over similar frequency bands for similar communication protocols.

As shown in FIG. 2, the first radiating portion 116 can face in a first direction (e.g., in the negative x-direction) while the second radiating portion 116′ can face in an opposite second direction (e.g., the positive y-direction). For example, the first radiating portion 116 can be rotated 180-degrees relative to the second radiating portion 116′ For further clarity, the direction a radiating portion “faces” can be defined at least in part by the side that contains the conductive material (e.g., the upright conductive portions 118, 118′, the conductive arm portions 122, 124, 122′, 124′, etc.). Arranging in a linear manner with the first radiating portion 116 and the second radiating portion 116′ to face opposite directions can provide certain benefits. For example, this arrangement can provide for greater coverage area, without interacting or creating interference between the first radiating portion 116 and the second radiating portion 116′. In some cases, the second radiating portion 116′ is a mirror image of the first radiating portion 116, which can help create an approximately 360-degree coverage area for signal absorption and transmission, thus creating a larger surface area for better overall cellular coverage of the multi-element multi-band antenna 102. Additionally, this arrangement can allow the antenna assembly 100 to have an aerodynamic profile, without compromising the coverage.

FIG. 3 illustrates a grounding portion 130 of the first radiating portion 116. The grounding portion 130 can be a ground conductive portion 132 on a ground PCB portion 134. The grounding portion 130 is configured to provide a conductive path between the first radiating portion 116 and the internal ground plane 110. The ground conductive portion 132 can have a height 109 relative to the base PCB portion 112, a width 111 relative to the first upright PCB portion 114, a length 113 which defines the height of the actual conductive material, and a clearance 115 which defines the distance between the feeding portion 120 of the first radiating portion 116 and the grounding location (e.g., the location of the first base projection 136a). The combination of approximately the height 109 and the clearance 115 of the grounding portion 130 can define the grounding length. In some cases, the height to the base of ground conductive portion 132 relative from the base PCB portion 112 (e.g., the height 109 minus the length 113) can also impact the grounding length. In some cases, the clearance 115 can be between 0.06 inches and 3 inches, however, other sizes are possible. In some cases, the height to the base of ground conductive portion 132 relative from the base PCB portion 112 (e.g., the height 109 minus the length 113) can range from 0.06 inches to the height 101 of the upright conductive portion 118.

The grounding portion 130 may be coupled to the first radiating portion 116 at at least one point and the internal ground plane 110 at at least one point. The ground PCB portion 134 may be coupled to and extend from the base PCB portion 112. For example, the ground PCB portion 134 can be positioned in one or more slots or cut-outs of the base PCB portion 112. In the illustrated example, the ground PCB portion 134 includes two base projections, a first base projection 136a and a second base projection 136b. Other numbers of projections are possible. The ground conductive portion 132 extends along one or both of the two projections 136a, 136b. In the illustrated example, the ground conductive portion 132 extends along only the first base projection 136a. Similarly, the base PCB portion 112 includes two base slots, a first slot 138a and a second base slot 138b. Other numbers of slots are possible. The slots 138a, 138b may extend through the base PCB portion 112 to provide access to the internal ground plane 110. This arrangement allows the grounding portion 130 to be electrically connected to the internal ground plane 110 (e.g., via the electrical connection between the ground conductive portion 132 and the internal ground plane 110). For further clarity, the grounding portion 130 is electrically connected to the internal ground plane 110 at the intersection between the ground conductive portion 132 and the internal ground plane 110, where the first base projection 136a contacts the first slot 138a. Those skilled in the art will understand that only one point of electrical connection is required between the grounding portion 130 and the internal ground plane 110. The interaction between the second base slot 138b and the second base projection 136b can provide mechanical stability and support for the ground PCB portion 134. Optionally, in some implementations, the ground conductive portion 132 can extend along the second base projection 136b and provide a second electrical connection at the second base slot 138b.

The ground PCB portion 134 can be generally perpendicular relative to the base PCB portion 112. For example, the ground PCB portion 134 may extend from the base PCB portion 112 at approximately a 90-degree angle (e.g., between 85-degrees and 95-degrees). In other implementations, different angles are possible. Similarly, the ground PCB portion 134 can be coupled to the first upright PCB portion 114. The ground PCB portion 134 may be generally perpendicular relative to the first upright PCB portion 114. For example, the ground PCB portion 134 may extend from the first upright PCB portion 114 at approximately a 90-degree angle (e.g., between 85-degrees and 95-degrees). In other implementations, different angles are possible.

The ground PCB portion 134 can include one or more side projections that extend through corresponding slots/holes in the first upright PCB portion 114. In the illustrated example, the ground PCB portion 134 includes two side projections, a first side projection 140a and a second side projection 140b. Other numbers of projections are possible. The ground conductive portion 132 extends along the two side projections 140a, 140b. Similarly, the first upright PCB portion 114 includes two slots, a first slot 142a and a second slot 142b. Other numbers of slots are possible. The slots 142a, 142b may be formed in the upright conductive portion 118. This arrangement allows the first radiating portion 116 to be electrically connected to the grounding portion 130 (e.g., via the electrical connection between the upright conductive portion 118 and the ground conductive portion 132). For further clarity, the first radiating portion 116 is electrically connected to the grounding portion 130 at the intersection between the upright conductive portion 118 and the ground conductive portion 132, where the two side projections 140a, 140b meet and contact the two slots 142a, 142b. Those skilled in the art will understand that only one point of electrical connection is required. However, having two points of coupling and electrical connection can provide advantages of greater stability and connection between the first upright PCB portion 114 and the ground PCB portion 134. In some cases, the grounding portion 130 can be soldered at one or more locations for mechanical stability and/or electrical connection. For example, the grounding portion 130 can be soldered at the locations of the four projections (e.g., at the two side projections 140a, 140b to the first radiating portion 116, and at the two base projections 136a, 136b to the base PCB portion 112).

The low band operation of the first radiating portion 116 can be impacted by several factors. Some non-limiting non-exhaustive factors can include: the height 101 and width 103 of the upright conductive portion 118, the length 105 and maximum width 107 of the head conductive portion 126, the location of the first slot 138a (e.g., which can define the electrical connection point for the ground conductive portion 132 and the internal ground plane 110) relative to the feeding portion 120 of the first radiating portion 116, and the shape of the grounding portion 130. In some implementations, one or more of the height 109, width 111, length 113, and clearance 115 of the ground conductive portion 132 can provide a reactance that can counter-balance the reactance of the low band impedance of the first radiating portion 116. This interaction can provide a resonance of a desired impedance match for the desired frequency and bandwidth for the low band radiation of the first radiating portion 116. This interaction can also provide the frequency location for the higher odd order resonances in the multi-band nature of the multi-element multi-band antenna 102. In some implementations, the location of the first slot 138a (e.g., which can define the electrical connection point for the ground conductive portion 132 and the internal ground plane 110), the width 111 and length 113 of the ground conductive portion 132, the height 101 of the first radiating portion 116, and the length 105 of the head conductive portion 126 can be configured to provide higher odd order resonant harmonics at the desired locations to cover a portion of the frequency band of the multi-band performance of the multi-element multi-band antenna 102.

In some implementations, including the implementation illustrated, the second radiating portion 116′ of the multi-element multi-band antenna 102 can include a second grounding portion 130′. The second grounding portion 130′ can include a second ground conductive portion 132′ formed on a second ground PCB portion 134′. The second grounding portion 130′ is configured to provide a conductive path between the second radiating portion 116′ and the internal ground plane 110. The second grounding portion 130′ can be identical to the grounding portion 130 and can include all the same components of the grounding portion 130 described herein (e.g., referred to with a “prime” symbol herein).

Referring back to FIG. 2, the second grounding portion 130′ can be positioned inwardly of the second upright PCB portion 114′ on the base PCB portion 112 (e.g., in a direction along the x-axis towards the first radiating portion 116). The second grounding portion 130′ can be positioned relative to the second upright PCB portion 114′ on the base PCB portion 112 in the same manner and arrangement as the grounding portion 130 is relative to the first upright PCB portion 114 and the base PCB portion 112. In some implementations, the grounding portion 130 can be coplanar to the second grounding portion 130′. In some implementations, the grounding portion 130 is not-coplanar to the second grounding portion 130′.

The multi-element multi-band antenna 102 can optionally include one or more additional radiating portions. In the illustrated example, the multi-element multi-band antenna 102 includes a third radiating portion 144, a fourth radiating portion 146, and a fifth radiating portion 148. More or less additional radiating portions are possible. The one or more of the additional radiating portions 144, 146, and 148 can be configured for multi-band WiFi radios. For example, these additional radiating portions 144, 146, 148 can be multi-band WiFi antenna devices. As such, the additional radiating portions 144, 146, and 148 can be configured for mid band and high band operation. In some cases, the additional radiating portions 144, 146, and 148 can have an operating range of approximately 1.7 GHz to 8 GHz.

The third radiating portion 144 can be a third conductive portion 150 formed on a third upright PCB portion 152. The third conductive portion 150 can be coupled to a feeding portion 154 at the base of the third conductive portion 150. The feeding portion 154 is used to electrically excite the third radiating portion 144. In some cases, the third conductive portion 150 can include a central conductive portion 151 and a first arm 153 and a second arm 155, all etched into the PCB portions 152. The central conductive portion 151 can be generally T-shaped. In some cases, the central conductive portion 151 can be used for the 2.4 GHz to 2.5 GHz portion of the WiFi band. In some cases, the first arm 153 and second arm 155 can be used to cover the 4.8 GHz to 8 GHz of the WiFi band. In some cases, the height and width of the central element of the central conductive portion 151 (e.g., between the two arms of the “T”) can be selected for the impedance matching of the two bands.

Similarly, the fourth radiating portion 146 can be a fourth conductive portion 156 formed on a fourth upright PCB portion 158. The fourth conductive portion 156 can be coupled to a feeding portion 160 at the base of the fourth radiating portion 146. The feeding portion 160 is used to electrically excite the fourth radiating portion 146. Similarly, the fifth radiating portion 148 can be a fifth conductive portion 162 formed on a fifth upright PCB portion 164. The fifth conductive portion 162 can be coupled to a feeding portion 166 at the base of the fifth conductive portion 162. The feeding portion 166 is used to electrically excite the fifth radiating portion 148. The fourth conductive portion 156 and the fifth conductive portion 162 can have the same shape described above with reference to the third conductive portion 150.

The additional radiating portions 144, 146, and 148 can be positioned near the edges of the base PCB portion 112 such that their respective PCB portions 152, 158, 164 are coupled to and extend from the base PCB portion 112. The PCB portions 152, 158, 164 can be generally perpendicular to the base PCB portion 112. For example, PCB portions 152, 158, 164 can extend at approximately a 90-degree angle (e.g., between 85-degrees and 95-degrees) from the base PCB portion 112. In other implementations, different angles are possible. In some cases, the positions of the multi-band WiFi portions 144, 146, and 148 about the support base 108 can be selected to provide isolation between the various multi-band WiFi portions 144, 146, and 148 as well as isolation between the portions multi-band WiFi portions 144, 146, and 148 and the cellular antennas (e.g., the first radiating portion 116 and the second radiating portion 116′). Additionally, these positions can be chosen with a goal of not disturbing the impedance match of the cellular antennas 116, 116′ while still maintaining reasonable antenna patterns for both the multi-band WiFi portions 144, 146, and 148 and the first radiating portion 116 and the second radiating portion 116′.

The multi-element multi-band antenna 102 can optionally include one or more GPS radiating portions. In the illustrated example, the multi-element multi-band antenna 102 includes a GPS radiating portion 168 (also referred to herein as a “GPS radiating device”). The GPS radiating portion 168 can be used to collect signal(s) from geosynchronous satellites so that the GPS function of a radio including the multi-element multi-band antenna 102 can determine where the multi-element multi-band antenna 102 is positioned relative to a global coordinate system. The GPS 168 may be positioned within and extend through a hole in the base PCB portion 112 in the assembled multi-element multi-band antenna 102. In the assembled multi-element multi-band antenna 102, the GPS radiating portion 168 may be electrically and/or mechanically coupled to the internal ground plane 110.

The base PCB portion 112 of the multi-element multi-band antenna 102 can include a plurality of microstrip transmission lines 170. The number of microstrip transmission lines included in the multi-element multi-band antenna 102 can be determined by the number of radiating portions included in the multi-element multi-band antenna 102. In the illustrated example, the multi-element multi-band antenna 102 includes five radiating portions (e.g., the first radiating portion 116, second radiating portion 116′, third radiating portion 144, fourth radiating portion 146, and the fifth radiating portion 148). As such, the multi-element multi-band antenna 102 includes five microstrip transmission lines, a first microstrip transmission lines 170a, a second microstrip transmission lines 170b, a third microstrip transmission lines 170c, a fourth microstrip transmission lines 170d, and a fifth microstrip transmission lines 170e, collectively referred to as the plurality of microstrip transmission lines 170. Each microstrip transmission line of the plurality of microstrip transmission lines 170 extends between the feeding portion (e.g., feeding portion 120) of individual radiating portions (e.g., the first radiating portion 116) and to an individual coaxial cable 172, described further below. The plurality of microstrip transmission lines 170 are used to electrically excite the various radiating portions. In some implementations, the plurality of microstrip transmission lines 170 provide a benefit of an economical use of space to route microwave energy from a location near the center of the support base 108 and connecting to various radiating portions dispersed across the internal ground plane 110. While in some cases, it may be preferable to connect the radiating portions to the center of the internal ground plane 110 via the plurality of microstrip transmission lines 170 and coaxial cables 172, other suitable ways to transport the microwave energy from the radios to the radiating portions are also within the scope of the present disclosure. Economics, environmental, and volumetric space constraints allow for engineering alternatives to the final packaging solution in some implementations. Generally, it is desirable for the spacing between the plurality of microstrip transmission lines 170 and the internal ground plane 110 to be less than 1 mm, which can allow the multi-element multi-band antenna 102 to operate effectively up to ranges of at least 6 GHz. For example, the non-conductive portion of the base PCB portion 112 can be less than 1 mm thick.

FIG. 4 illustrates a perspective isolation view of the internal ground plane 110 and a plurality of coaxial cables 172 (also referred to herein as “coaxial transmission lines”) of the multi-element multi-band antenna 102. As noted above, the internal ground plane 110 can be a conductive surface formed on the bottom of the base PCB portion 112. The coaxial cables 172 are the transmission lines that allow for the radio frequency “RF” signal to travel from the output of the radio used to establish the wireless link from the basestation to the mobile radio of the users of the wireless network. The coaxial cables 172 may require proper connection to the particular components of the multi-element multi-band antenna 102 so that it can function properly.

The number of coaxial cables 172 included in the multi-element multi-band antenna 102 can be determined by the number of radiating portions included in the multi-element multi-band antenna 102. In the illustrated example, the multi-element multi-band antenna 102 includes five radiating portions (e.g., the first radiating portion 116, second radiating portion 116′, third radiating portion 144, fourth radiating portion 146, and the fifth radiating portion 148). As such, the multi-element multi-band antenna 102 includes five coaxial cables 172, a first coaxial cable 172a, a second coaxial cable 172b, a third coaxial cable 172c, a fourth coaxial cable 172d, and a fifth coaxial cable 172e, collectively referred to as the coaxial cables 172.

The coaxial cables 172 may each include a center conductor (not shown) positioned within an outer conductor 174. For example, the coaxial cables 172a, 172b, 172c, 172d, and 172e include an outer conductor 174a, 174b, 174c, 174d, and 174e respectively. The coaxial cables 172 can be coupled to the internal ground plane 110. For example, the coaxial cables 172 can be soldered to the internal ground plane 110. In some cases, the coaxial cables 172 can each include a three-legged crimped connector. For example, as shown in FIG. 4 each include coaxial cables 172 include three legs 176 of the three-legged crimped connector. The three-legged crimped connector can be used to solder the coaxial cables 172 to the base PCB portion 112. The coaxial cables 172 can be soldered to the base PCB portion 112 in the confined circular hole in the center of the base PCB portion 112 while still maintaining good RF connection. The solder may be used to establish a soldered connection between the outer conductors 174 and the internal ground plane 110. For example, as shown in FIG. 4, five coaxial cables 172 are soldered onto the internal ground plane 110, with the center conductors extending through cable holes (not shown) of the internal ground plane 110 towards the coaxial inputs/holes (not shown) of the base PCB portion 112.

In the multi-element multi-band antenna 102, the center conductors of the coaxial cables 172 are electrically connected to the microstrip transmission lines 170 at the coaxial inputs of the base PCB portion 112. In some cases, the center conductors of the coaxial cables 172 can soldered to the coaxial inputs of the base PCB portion 112, which results in the coaxial cables 172 being electrically coupled to the plurality of microstrip transmission lines 170 and the radiating portions 116, 116′, 144, 146, 148.

In some implementations, other techniques can be employed to establish the electrical connection. For example, mechanical clamps with threaded fasteners can be used, spring loaded contacts can be used, electromagnetic coupling can be used, and/or the like. In the electromagnetic coupling example, the two conducting surface (e.g., the center conductor and the transmission lines 170) do not physically touch but are in sufficiently close proximity to one another by a non-conductive material (e.g., the base PCB portion 112) that provides a stable and consistent mechanical alignment. While soldering is used to establish the electrical connection between the outer conductors 174 of the coaxial cables 172 in the illustrated implementation, in other implementations, the same types of connection discussed for the center conductor can be used to electrically coupled the outer conductor 174 and the internal ground plane 110 of the multi-element multi-band antenna 102. In some implementations, the coaxial cables 172 can be located near the center of the internal ground plane 110 and the center of the support base 108.

FIG. 5A illustrates a top isolation view of the base PCB portion 112 of the antenna assembly 100. FIG. 5B illustrates a bottom isolation view of the internal ground plane 110 formed on the bottom side of the base PCB portion 112 of the antenna assembly 100. FIG. 5C illustrates a perspective isolation view of the base PCB portion 112 interacting with the coaxial cables 172 of the antenna assembly 100. FIG. 5D illustrates a perspective isolation view of the coaxial cables 172.

With reference to FIGS. 4-5D, the base PCB portion 112 can include one or more heat relief portion 178 (also referred to herein as “reliefs”). In some cases, the one or more heat relief portion 178 can be formed on the top side and/or the bottom side (e.g., the internal ground plane 110) of the base PCB portion 112. The reliefs 178 can be slits or cutouts in the conductive material of the internal ground plane 110 and/or on the conductive material on the top side of the base PCB portion 112, exposing the non-conducive base PCB portion 112. In some examples, each outer conductor 174 of the coaxial cables 172 can be positioned between a pair of adjacent one or more reliefs 178. As discussed above, the outer conductors 174 of the coaxial cables 172 may be soldered to the bottom side of the internal ground plane 110 to electrically connect each outer conductor 174 to the internal ground plane 110. When arranged in the manner shown in FIGS. 4-10B, the plurality of reliefs 178 may serve as a stopping point or dam to contain the placement of the solder during the soldering process. For example, the one or more reliefs 178 can provide thermal management, such as inhibiting the conduction of heat in its flow into the expanse of the PCB 112 and the other coaxial cables 172 during the assembly (e.g., soldering) process. In some cases, the heat flow preferably encounters significant thermal resistance while the microwave energy moving along the microstrip transmission lines 170 embedded in the base PCB portion 112 is not disturbed.

As shown in FIG. 5A, the top side of the base PCB portion 112 can include the plurality of microstrip transmission lines 170, which can feed to the center of the base PCB portion 112. Each of the plurality of microstrip transmission lines 170 can feed to a hole for receiving the center conductor of the coaxial cables 172. The center of the base PCB portion 112 can receive the plurality of coaxial cables 172. As shown in FIGS. 5C and 5D and discussed herein, the coaxial cables 172 can be designed as three-legged crimped connectors. For example, each coaxial cables 172 can include three legs 176. As such, the base PCB portion 112 shown in FIG. 5A can include three holes for receiving the three legs 176 and a central hole for receiving the center connector of the coaxial cables 172. The three holes can be positioned around the central hole. The three holes in combination with the three legs 176 can allow the coaxial cables 172 to be soldered to the ground reference 112.

As shown in FIGS. 5C and 5D, the antenna assembly 100 can include five coaxial cables 172. The number of coaxial cables 172 can be selected based on the number of radiating portions in the antenna assembly 100. The thermal relief features (e.g., including the one or more heat relief portion 178) can allow the coaxial cables 172 to be positioned close together, which can be desirable for reducing the size of the antenna assembly 100.

In some implementations, any of the PCB portions (e.g., the first upright PCB portion 114, second upright PCB portion 114′, PCB portion 152, PCB portion 158, PCB portion 164) of the various radiating portions can be a portion of the base PCB portion 112. For example, the various PCB portions that the radiating portions are formed on can be arms of the base PCB portion 112 that are bent to the desired angle.

In some cases, each radiating portion (e.g., the first radiating portion 116, the second radiating portion 116′, the third radiating portion 144, the fourth radiating portion 146, the fifth radiating portion 148) may be/function as monopole antennas. Each of the radiating elements 116, 116′, 144, 146, 148 can cover the full bandwidth of the radio that is connected to it, with each radiating element 116, 116′, 144, 146, 148 having a unique radio. In some implementations, the radiating elements 116, 116′, 144, 146, 148 work together in a Multiple-Input Multiple-Output (“MiMo”) aspect of the radio link.

In some implementations, one or more of the radiating portion (e.g., the first radiating portion 116, the second radiating portion 116′, the third radiating portion 144, the fourth radiating portion 146, the fifth radiating portion 148) can include one or more apertures. For example, the one or more apertures may extend through the both the conductive portion and the PCB portion of the radiating portions. The apertures can be any suitable shape, such as circular, oval, square, rectangular, elliptical, and/or the like. In some cases, including radiating portions with apertures can enhance the multi-element multi-band antenna's 102 performance and characteristics for some applications. In one example, apertures can be used to shape the radiation pattern of the multi-element multi-band antenna 102 (e.g., the shape and size of apertures can be used to direct and focus the radiation pattern on the multi-element multi-band antenna 102 in a specific direction, which can increase the gain and/or enhance the multi-element multi-band antenna's 102 directivity). In another example, apertures can be used as resonant structures such that the multi-element multi-band antenna 102 is a frequency-selective antenna (e.g., the size and shape of the apertures can be tuned to resonate at a specific frequency, which would make the multi-element multi-band antenna 102 more responsive at the specific frequency). Other benefits can also be realized by including apertures in one or more of the radiating portions.

In the example illustrated in FIGS. 2 and 3, the radiating portions (e.g., the first radiating portion 116, the second radiating portion 116′, the third radiating portion 144, the fourth radiating portion 146, the fifth radiating portion 148) can each include one or more soldering holes 180. The soldering holes 180 can be holes or apertures that extend through the radiating portions (e.g., the conductive portions and the PCB portions). Including soldering hole(s) 180 in the radiating portions can provide certain benefits. For example, the various radiating portions can be mechanically and/or electrically coupled to the base PCB portion 112 via the soldering hole(s) 180. The soldering hole(s) 180 can allow the solder to be placed on one side of the PCB portion and the soldering iron to be placed on the opposite side of the PCB portion. This arrangement can allow both sides of the PCB portions to be soldered at the same time, which can improve the manufacturability of the antenna assembly 100. For example, this arrangement can reduce the total amount of time required to solder the various PCB portions, which can be time consuming where the soldering holes 180 are not included.

In the illustrated example, the first radiating portion 116 can include a first soldering hole 180a. The first soldering hole 180a can extend through the upright conductive portion 118 at a central location on the bottom edge of the upright conductive portion 118. Similarly, the second radiating portion 116′ can include a second soldering hole 180b. The second soldering hole 180b can extend through the upright conductive portion 118′ at a central location on the bottom edge of the upright conductive portion 118′. Similarly, the radiating portions 144, 146, 148 can include a third soldering hole 180c, a fourth soldering hole 180d, and a fifth soldering hole 180e respectively. The soldering holes 180c, 180d, 180e can extend through the conductive portions 150, 156, 162 at a central location on the bottom edge of the conductive portions 150, 156, 162. The soldering holes 180 can be positioned slightly above the various feed points for the radiating portions, which in some cases, may help with impedance matching. While various soldering holes 180 are shown, it is recognized that the soldering holes 180 are not required. Additionally, individual radiating portions can include one or more soldering holes 180 while other radiating portions in the multi-element multi-band antenna 102 may not include soldering holes 180. While only one soldering hole 180 is shown in FIGS. 2 and 3, it is recognized that the various radiating portions can include more than one soldering hole 180 in various implementations, as explained herein.

As shown in at least FIGS. 2 and 3, any of the PCB portions that conductive portions are formed on (e.g., the first radiating portion 116, the second radiating portion 116′, the third radiating portion 144, the fourth radiating portion 146, the fifth radiating portion 148, the grounding portion 130, the second grounding portion 130′, etc.) can include one or more plated through holes 190. The plated through holes 190 can be conductive plates coupled to or formed on the PCB portions with through holes that extend through the PCB portion and the plates. For example, the first radiating portion 116 shown in FIG. 2 includes two plated through holes 190 on the bottom corners of the first upright PCB portion 114. Similarly, as shown in FIG. 3, the grounding portion 130 includes two plated through holes 190 on the bottom corners of the ground PCB portion 134. In yet another example, the third radiating portion 144, shown in FIG. 3, includes two plated through holes 190 on the bottom corners of the PCB portions 152. The plated through holes 190 can be formed on projections extending from the bottom edges of the PCB portions in some cases. The plated through holes 190 can be aligned and extend into plated slots 192 in the base PCB portion 112. The plated slots 192 can be conductive plates coupled to or formed on the base PCB portion 112 with through holes or slots that extend through the base PCB portion 112 and the plates. Including various PCB portions of the antenna assembly 100 with plated through holes 190 for aligning with plated slots 192 in the base PCB portion 112 can provide certain benefits. For example, the PCB portions can be soldered to the base PCB portion 112 at where the plated through holes 190 extend through the plated slots 192. For example, the solder can be placed on one side of the plated through holes 190 and the soldering iron can be placed on the opposite side of the plated through hole 190. This arrangement can allow for four soldering connections to be made at one time, which can improve the manufacturability of the antenna assembly 100. For example, this arrangement can reduce the total amount of time required to solder the various PCB portions to the base PCB portion 112, which can be time consuming where the plated through holes 190 and the plated slots 192 are not included. While only some of the PCB portions include labeled plated through holes 190, it is understood that any of the PCB portions in the antenna assembly 100 and the antenna assembly 200 can include plated through holes 190. Similarly, while only certain portions of the base PCB portion 112 include plated slots 192, it is understood that the base PCB portion 112 and the base PCB portion 212 of the antenna assembly 200 can include plated slots 192 at any location where a PCB portion can be soldered to the PCB base portion 112, 212. The plated slots 192 can be seen in FIG. 5A.

### Multi-Structure Multi-Element Multi-Band Antenna

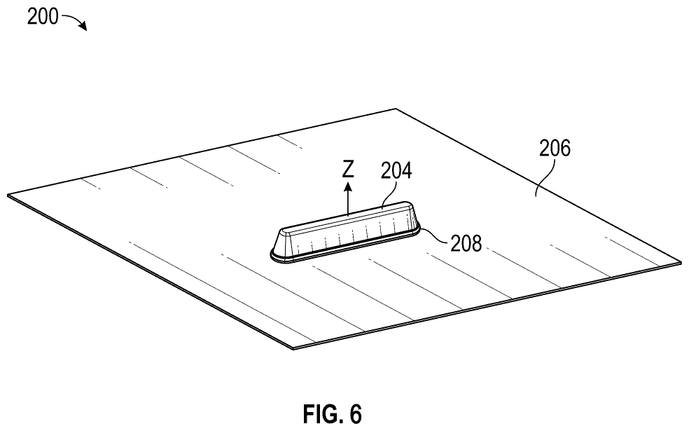

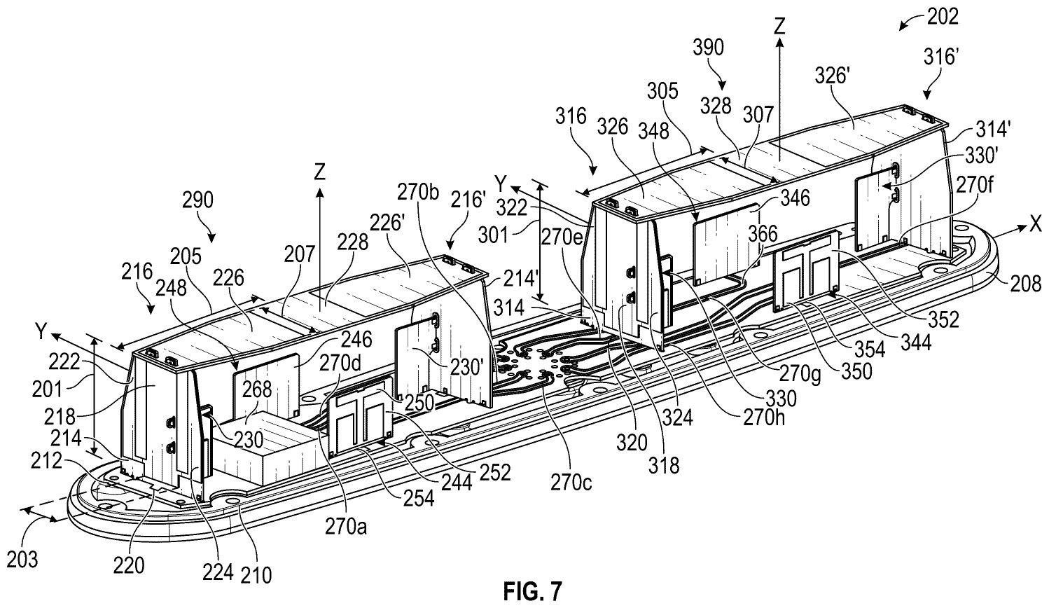

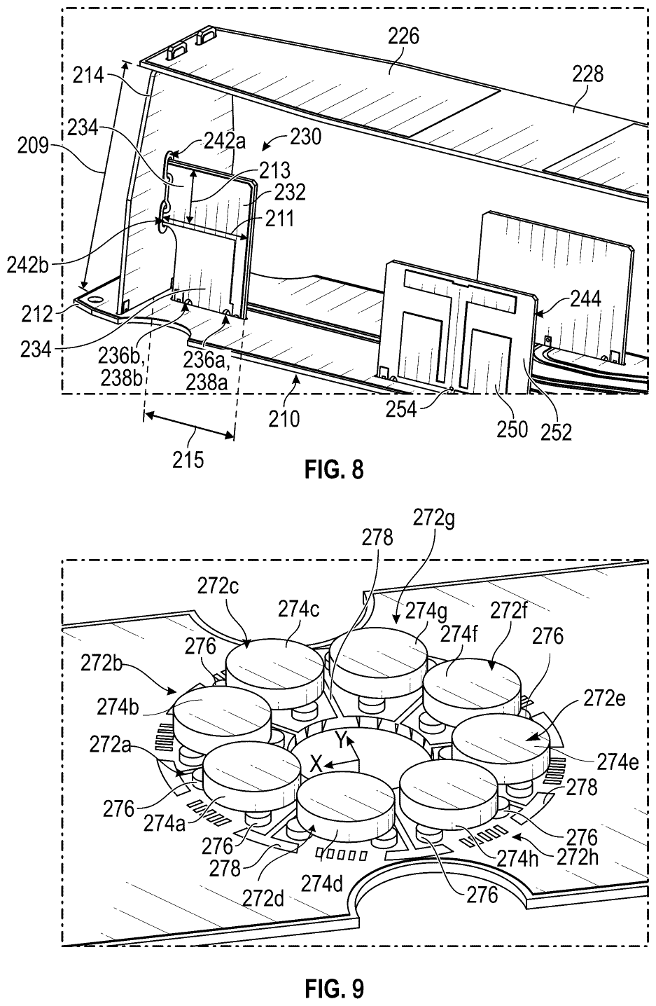

Referring now to the drawings of FIG. 6-9, wherein like reference characters identify corresponding or similar elements in form and function throughout the several views. FIGS. 6 and 7 illustrate top perspective views of an antenna assembly that can include a multi-element multi-band antenna on a ground plane showing the system with and without being enveloped by a non-conductive cover. FIGS. 8-10D illustrate assorted views of the multi-element multi-band antenna of FIG. 6 and showing isolation views of various components that may be included in the antenna assembly, according to some implementations.

In accordance with some aspects of this disclosure, a multi-band antenna comprises a feeding portion, a grounding portion, an upright low band radiation portion, a second low band radiation portion, and a high band radiation portion that is constructed of two arms that are attached to the base of the upright low band radiation portion. According to some implementations a multi-band antenna system comprises four such low/high multi-band antenna devices, coupled with four multi-band WiFi antenna devices, and a GPS radiating device, on one or more bases, and configured to be protected in use by a suitable cover device, and configured to be attached to a suitable ground plane. According to some implementations, the ground reference portion of the base preferably comprises eight coaxial inputs that are coupled to the microstrip transmission lines that are embedded in the ground reference portion. There can be one or more reliefs in the ground reference portion having a size, orientation, and shape that are preferably configured such that the conduction of the heat during the soldering process of the coaxial connectors is inhibited in its flow into the expanse of the ground reference portion and the other coaxial connectors. According to some implementations, the heat flow preferably encounters significant thermal resistance while the microwave energy moving along the microstrip transmission lines embedded in the ground reference portion is not disturbed.

According to some implementations, the upright low band radiation portion has a second portion that is coplanar to the first portion and a high band radiation portion that is constructed of two arms that are attached to the base of the upright low band radiation portion. In some implementations, the upright low band radiation portion has a second portion that is coplanar to the first portion and a high band radiation portion that is constructed of a single arm that attached to the base of the upright low band radiation portion. In some implementations, the upright low band radiation portion has a second portion that is not-coplanar to the first portion and a high band radiation portion that is constructed of a two arms that are attached to the base of the upright low band radiation portion. In some implementations, the upright low band radiation portion has a second portion that is not-coplanar to the first portion and a high band radiation portion that is constructed of a single arm that is attached to the base of the upright low band radiation portion. In some implementations, the upright low band radiation portion has a second portion that is coplanar to the first portion and a high band radiation portion that is constructed of a plurality of arms that are attached to the base of the upright low band radiation portion. In some implementations, the upright low band radiation portion has a second portion that is not-coplanar to the first portion and a high band radiation portion that is constructed of a plurality of arms that attached to the base of the upright low band radiation portion. In some implementations, the upright low band radiation portion has a second portion that is coplanar to the first portion and a high band radiation portion that is constructed of a plurality of arms of different lengths that are attached to the base of the upright low band radiation portion. In some implementations, the upright low band radiation portion has a second portion that is not-coplanar to the first portion and a high band radiation portion that is constructed of a plurality of arms of different lengths that attached to the base of the upright low band radiation portion.

According to some implementations, a multi-band antenna, comprises a feeding portion, a grounding portion, an upright low band radiation portion, a second low band radiation portion, a third low band radiation portion of one length coupled to the second low band radiation portion, and a high band radiation portion that is constructed of two arms that are attached to the base of the upright low band radiation portion.

According to some implementations, the upright low band radiation portion has a second portion that is coplanar to the first portion and a high band radiation portion that is constructed of two arms that are attached to the base of the upright low band radiation portion. According to some implementations, the upright low band radiation portion has a second portion that is coplanar to the first portion and a high band radiation portion that is constructed of a single arm that is attached to the base of the upright low band radiation portion. According to some implementations, the upright low band radiation portion has a second portion that is not-coplanar to the first portion and a high band radiation portion that is constructed of a two arms that are attached to the base of the upright low band radiation portion. According to some implementations, the upright low band radiation portion has a second portion that is not-coplanar to the first portion and a high band radiation portion that is constructed of a single arm that is attached to the base of the upright low band radiation portion. According to some implementations, the upright low band radiation portion has a second portion that is coplanar to the first portion and a high band radiation portion that is constructed of a plurality of arms that are attached to the base of the upright low band radiation portion. According to some implementations, the upright low band radiation portion has a second portion that is not-coplanar to the first portion and a high band radiation portion that is constructed of a plurality of arms that are attached to the base of the upright low band radiation portion. According to some implementations, the upright low band radiation portion has a second portion that is coplanar to the first portion and a high band radiation portion that is constructed of a plurality of arms of different lengths that are attached to the base of the upright low band radiation portion. According to some implementations, the upright low band radiation portion has a second portion that is not-coplanar to the first portion and a high band radiation portion that is constructed of a plurality of arms of different lengths that are attached to the base of the upright low band radiation portion.

According to some implementations, a multi-band antenna comprises a feeding portion, a grounding portion, an upright low band radiation portion, a second low band radiation portion, a third low band radiation portion of one length coupled to the second low band radiation portion, a fourth low band radiation portion of a length different to the third low band radiation portion while coupled to the second low band radiation portion while also coupled to the third low band radiation portion, and a high band radiation portion that is constructed of two arms that are attached to the base of the upright low band radiation portion.

According to some implementations, the upright low band radiation portion has a second portion that is coplanar to the first portion and a high band radiation portion that is constructed of two arms that are attached to the base of the upright low band radiation portion. According to some implementations, the upright low band radiation portion has a second portion that is coplanar to the first portion and a high band radiation portion that is constructed of a single arm that is attached to the base of the upright low band radiation portion. According to some implementations, the upright low band radiation portion has a second portion that is not-coplanar to the first portion and a high band radiation portion that is constructed of two arms that attached to the base of the upright low band radiation portion. According to some implementations, the upright low band radiation portion has a second portion that is not-coplanar to the first portion and a high band radiation portion that is constructed of a single arm that attached to the base of the upright low band radiation portion. According to some implementations, the upright low band radiation portion has a second portion that is coplanar to the first portion and a high band radiation portion that is constructed of a plurality of arms that are attached to the base of the upright low band radiation portion. According to some implementations, the upright low band radiation portion has a second portion that is not-coplanar to the first portion and a high band radiation portion that is constructed of a plurality of arms that are attached to the base of the upright low band radiation portion. According to some implementations, the upright low band radiation portion has a second portion that is coplanar to the first portion and a high band radiation portion that is constructed of a plurality of arms of different lengths that are attached to the base of the upright low band radiation portion. According to some implementations, the upright low band radiation portion has a second portion that is not-coplanar to the first portion and a high band radiation portion that is constructed of a plurality of arms of different lengths that are attached to the base of the upright low band radiation portion.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

FIGS. 6-10 illustrate an implementation on an antenna assembly 200 that includes a multi-element multi-band antenna 202. The multi-element multi-band antenna 202 may have particular benefits when used in places such as kiosks, vehicles, portable wireless access points, and/or the like, however, the multi-element multi-band antenna 202 may be used in a wide range of applications.

Some features of the antenna assembly 200 and the multi-element multi-band antenna 202 are similar or identical to features of the antenna assembly 100 and multi-element multi-band antenna 102 in at least FIG. 1-5D. Thus, reference numerals used to designate the various features or components of the antenna assembly 100 and multi-element multi-band antenna 102 are identical to those used for identifying the corresponding features of the components of the antenna assembly 200 and multi-element multi-band antenna 202 in FIGS. 6-10D, except that the numerical identifiers for the antenna assembly 200 and multi-element multi-band antenna 202 begin with a “2” or a “3” instead of a “1”. Therefore, the structure and description for the various features of the antenna assembly 100 and multi-element multi-band antenna 102 and the operation thereof as described in at least FIGS. 1-5D are understood to also apply to the corresponding features of the antenna assembly 200 and multi-element multi-band antenna 202 in FIG. 6-10D, except as described differently below.

The antenna assembly 200 differs from the antenna assembly 100 primarily in that the multi-element multi-band antenna 202 of the antenna assembly 200 includes two radiating structures, a first radiating structure 290 and a second radiating structure 390. The second radiating structure 390 can be identical to the first radiating structure 290. The term “radiating structure” as used with reference to FIGS. 6-10D refers to the various radiating and grounding portions of the multi-element multi-band antenna 202. The first radiating structure 290 can include the first radiating portion 216, the second radiating portion 216′, the grounding portion 230, the second grounding portion 230′, the third radiating portion 244, and the fourth radiating portion 246. The second radiating structure 390 can include the first radiating portion 316, the second radiating portion 316′, the grounding portion 330, the second grounding portion 330′, the third radiating portion 344, and the fourth radiating portion 346. Both the first radiating structure 290 and the second radiating structure 390 can be mechanically coupled to the same base PCB portion 212 and electrically coupled to the same internal ground plane 210.

In some cases, a user may use the antenna assembly 200 over the antenna assembly 100 when there are two different two port radios or there is a four port radio. In some implementations, the antenna assembly 200 can include additional radiating structures (e.g., like the first radiating structure 290 and second radiating structure 390) that can push the number of ports to 16, 32, or 64 ports or even higher. For example, the additional radiating structures could be arranged in an array. In some implementations, an antenna can include 2, 4, 6, 8, 10, 12, 14, 16, 32, 64 and/or the like radiating structures arranged in an array. In some cases, an antenna system can include a plurality of antenna assemblies 200 arranged in an array. For example, FIG. 11 illustrates an antenna system 400 that include eight antenna assemblies 200 arranged in an array. In other example, the antenna system 400 can include, 2, 4, 6, 10, 12, 14, 16, 32, 64, and/or the like antenna assemblies 200 arranged in an array.

With reference to FIG. 6, the antenna assembly 200 may differ from the antenna assembly 100 in that the antenna assembly 200 is larger (e.g., has a greater volume). For example, the antenna assembly 200 may include a radome 204 that is larger than the radome 104 and a support base 208 that is larger than the support base 108. In some implementations, the assembled antenna assembly 200 may have an approximate length of less than 14 inches, an approximate width of two inches, and an approximate height of one and a half inches. For example, the total length of the antenna assembly 200 can change to accommodate the second radiating structure 390, but the width and height of the antenna assembly 200 can be the same as the antenna assembly 100 in some cases, thus maintaining the aerodynamic profile of the antenna assembly 200. However, antenna assembly 200 may not always be larger than the antenna assembly 100.

With reference to FIG. 7, both the first radiating structure 290 and the second radiating structure 390 are mounted to the same base PCB portion 212. The multi-element multi-band antenna 202 can also differ from the multi-element multi-band antenna 102 in the number of WiFi radiating devices included. For example, the first radiating structure 290 can include two WiFi radiating devices (e.g., the third radiating portion 244 and the fourth radiating portion 246) and the second radiating structure 390 can also include two WiFi radiating devices (e.g., the third radiating portion 344 and the fourth radiating portion 346). As such, the multi-element multi-band antenna 202 can include four WiFi radiating devices, while the example multi-element multi-band antenna 102 illustrated in FIGS. 1-5D includes only three WiFi radiating devices (e.g., the third radiating portion 144, the fourth radiating portion 146, and the fifth radiating portion 148). However, as noted herein, the number of WiFi radiating devices included in either the multi-element multi-band antenna 102 or the multi-element multi-band antenna 202 is variable. As such, different numbers of WiFi radiating devices are possible for both the multi-element multi-band antenna 202 and the multi-element multi-band antenna 102.

With reference to FIGS. 7 and 9, because the multi-element multi-band antenna 202 includes more radiating portions than the multi-element multi-band antenna 102, the multi-element multi-band antenna 202 also includes more microstrip transmission lines 270 and coaxial cables 272. For example, the multi-element multi-band antenna 202 can include eight microstrip transmission lines 270 and eight coaxial cables 272 for the eight radiating portions (e.g., the first radiating portion 216, the second radiating portion 216′, the third radiating portion 244, and the fourth radiating portion 246, the first radiating portion 316, the second radiating portion 316′, the third radiating portion 344, and the fourth radiating portion 346). However, it is recognized that more or less microstrip transmission lines 270 and coaxial cables 272 are possible for varying numbers of radiating portions. The microstrip transmission lines 270 can be fed to a center hole of the support base 208 where the coaxial cables 272 can extend through. The center hole can be positioned between the first radiating structure 290 and the second radiating structure 390.

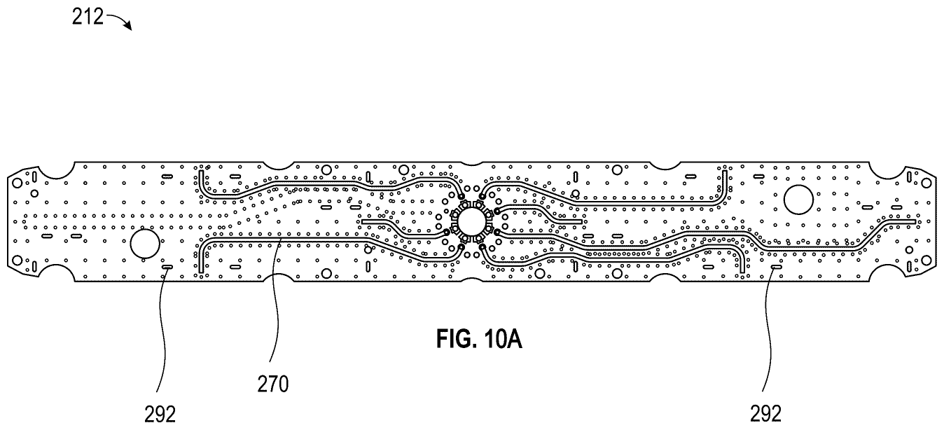

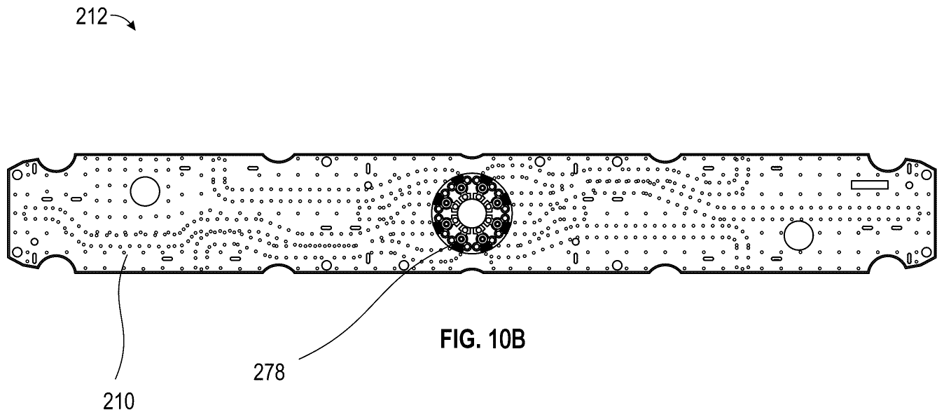

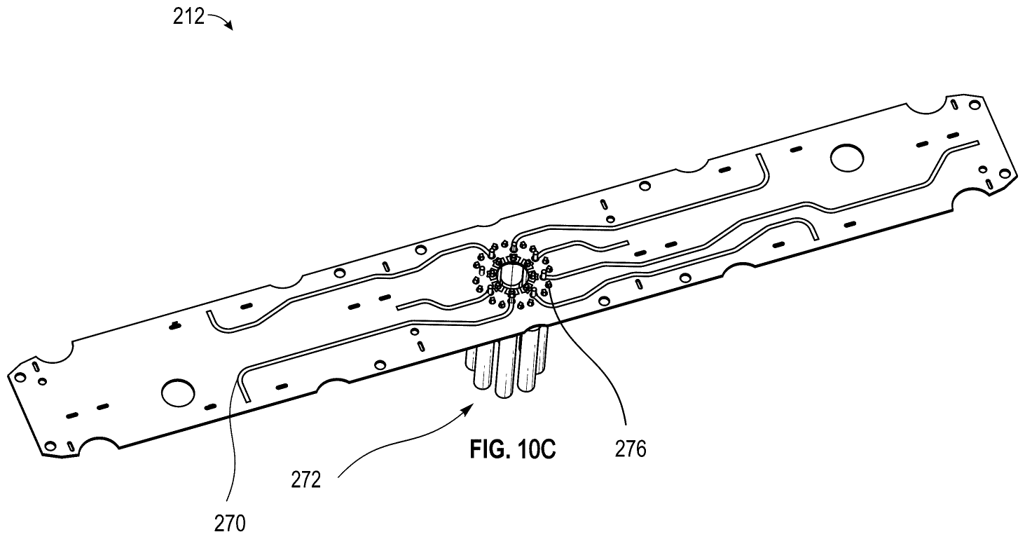

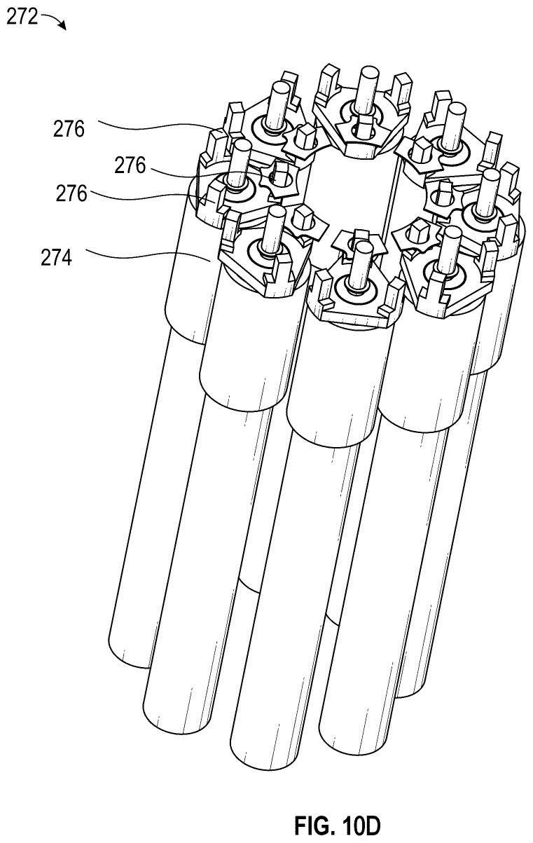

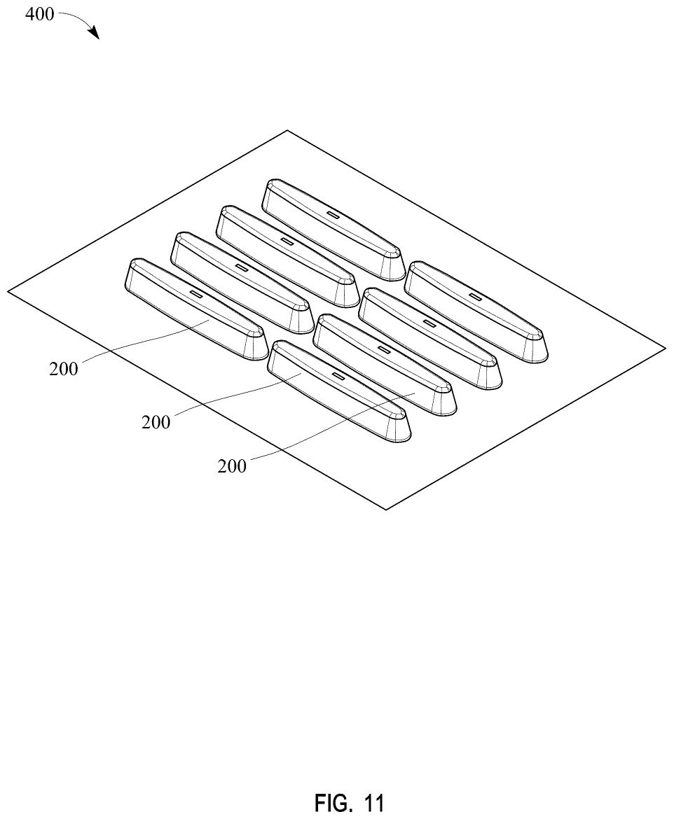

FIG. 10A illustrates a top isolation view of the base PCB portion 212 of the antenna assembly 200. FIG. 10B illustrates a bottom isolation view of the same internal ground plane 210 formed on the bottom side of the base PCB portion 212 of the antenna assembly 200. FIG. 10C illustrates a perspective isolation view of the base PCB portion 212 interacting with the coaxial cables 272 of the antenna assembly 200. FIG. 5D illustrates a perspective isolation view of the coaxial cables 272.

With reference to FIGS. 9-10D, the base PCB portion 112 can include one or more heat relief portion 278 (also referred to herein as “reliefs”). In some cases, the one or more heat relief portion 278 can be formed on the top side and/or the bottom side (e.g., the internal ground plane 210) of the base PCB portion 212. The reliefs 278 can be slits or cutouts in the conductive material of the internal ground plane 210 and/or on the conductive material on the top side of the base PCB portion 212, exposing the non-conducive base PCB portion 212. In some examples, each outer conductor 274 of the coaxial cables 272 can be positioned between a pair of adjacent one or more reliefs 278. As discussed above, the outer conductors 274 of the coaxial cables 272 may be soldered to the bottom side of the internal ground plane 210 to electrically connect each outer conductor 274 to the internal ground plane 210. When arranged in the manner shown in FIG. 9-10B, the plurality of reliefs 278 may serve as a stopping point or dam to contain the placement of the solder during the soldering process. For example, the one or more reliefs 278 can provide thermal management, such as inhibiting the conduction of heat in its flow into the expanse of the PCB 212 and the other coaxial cables 272 during the assembly (e.g., soldering) process. In some cases, the heat flow preferably encounters significant thermal resistance while the microwave energy moving along the microstrip transmission lines 270 embedded in the base PCB portion 212 is not disturbed.

As shown in FIG. 10A, the top side of the base PCB portion 212 can include the plurality of microstrip transmission lines 270, which can feed to the center of the base PCB portion 212. Each of the plurality of microstrip transmission lines 270 can feed to a hole for receiving the center conductor of the coaxial cables 272. The center of the base PCB portion 212 can receive the plurality of coaxial cables 272. As shown in FIGS. 10C and 10D and discussed herein, the coaxial cables 272 can be designed as three-legged crimped connectors. For example, each coaxial cables 272 can include three legs 276. As such, the base PCB portion 212 shown in FIG. 10A can include three holes for receiving the three legs 276 and a central hole for receiving the center connector of the coaxial cables 272. The three holes can be positioned around the central hole. The three holes in combination with the three legs 276 can allow the coaxial cables 272 to be soldered to the ground reference 212.

As shown in FIGS. 10C and 10D, the antenna assembly 200 can include eight coaxial cables 272. The number of coaxial cables 272 can be selected based on the number of radiating portions in the antenna assembly 200. The thermal relief features (e.g., including the one or more heat relief portion 278) can allow the coaxial cables 272 to be positioned close together, which can be desirable for reducing the size of the antenna assembly 200.

As shown in FIG. 7, the first radiating structure 290 and the second radiating structure 390 are linearly arranged on the support base 208 with a gap therebetween. This linear arrangement can provide certain benefits, such as an improved aerodynamic profile of the antenna assembly 200 without significantly compromising the performance of the antenna assembly 200. In some cases, the gap between the first radiating structure 290 and the second radiating structure 390 (e.g., between the upright PCB portion 214′ and the upright PCB portion 314) can be approximately 2.5 inches. This gap can be selected to minimize the interference between the first radiating structure 290 and the second radiating structure 390 and can vary. In some cases, the gap of 2.5 inches can provide for sufficient isolation, while in other cases a larger or small gap can be used. For example, in some cases, a gap of between about 2 inches and about 3 inches can be used. For example, in some cases, a gap of between about 2 inches and about 4 inches can be used. As discussed with reference to FIG. 2, the direction of the various radiating portions of the antenna assemblies can be selected to maximize coverage. For example, the first radiating portion 216 of the first radiating structure 290 can face in a first direction (e.g., in the negative x-direction) while the second radiating portion 216′ can face in an opposite second direction (e.g., the positive y-direction). Similarly, the first radiating portion 316 of the second radiating structure 390 can face in the first direction (e.g., in the negative x-direction) while the second radiating portion 316′ can face in the opposite second direction (e.g., the positive y-direction). Arranging in a linear manner with the first radiating portions 216, 316 and the second radiating portions 216′, 316′ to face opposite directions can provide certain benefits. For example, this arrangement can provide for greater coverage area, without interacting or creating interference between the first radiating portion 216 and the second radiating portion 216′ or the first radiating portion 316 and the second radiating portion 316′. In some cases, the second radiating portions 216′, 316′ are mirror images of the first radiating portions 216, 316, which can help create an approximately 360-degree coverage area for signal absorption and transmission, thus creating a larger surface area for better overall cellular coverage of the multi-element multi-band antenna 202. Additionally, this arrangement can allow the antenna assembly 200 to have an aerodynamic profile, without compromising the coverage. In the antenna assembly 200, there can be two sets of 2×2 cellular antennas (e.g., formed by the first radiating portion 216 and the second radiating portion 216′ and the first radiating portion 316 and the second radiating portion 316′). The cellular antenna can be paired with one or more GPS antennas (e.g., GPS radiating portion 268) and one or more dual-band WiFi antennas (e.g., third radiating portion 244, fourth radiating portion 246, third radiating portion 344, fourth radiating portion 346) in a small profile radome 204.

While not illustrated in FIGS. 6-10D, it is recognized that any of the PCB portions of the antenna assembly 200 can include soldering holes like the soldering holes 180 described with reference to FIGS. 1-4. Similarly, any of the PCB portions of the antenna assembly 200 can include plated through holes, like the plated through holes 190 described with reference to FIGS. 2 and 3. Like in the base PCB portion 112 of the antenna assembly 100, the base PCB portion 212 can include plated slots like the plated slots 192 described with reference to FIGS. 2 and 3. The plated through holes can be aligned and soldered to the plated slots in the antenna assembly 200, thus improving the manufacturability of the antenna assembly 200.

The particular implementations disclosed above are illustrative only, as the application may be modified and practiced in different but equivalent manners apparent to those skilled in the art having the benefit of the teachings herein. It is therefore evident that the particular implementations disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

### EXAMPLE CLAUSES

Various examples of systems relating to an antenna system are found in the following clauses:
Clause 1. A multi-band antenna, comprising: a feeding portion; a grounding portion; an upright low band radiation portion; a second low band radiation portion; and a high band radiation portion.
Clause 2. The multi-band antenna of Clause 1, wherein the second low band radiation portion is not-coplanar with the upright low band radiation portion.
Clause 3. The multi-band antenna of Clause 1, wherein the second low band radiation portion is coplanar with the upright low band radiation portion.
Clause 4. The multi-band antenna of any of Clauses 1-3, wherein the high band radiation portion comprises two arms coupled to a base of the upright low band radiation portion.
Clause 5. The multi-band antenna of any of Clauses 1-3, wherein the high band radiation portion comprises a single arm coupled to a base of the upright low band radiation portion.
Clause 6. The multi-band antenna of any of Clauses 1-3, wherein the high band radiation portion comprises a plurality of arms coupled to a base of the upright low band radiation portion.
Clause 7. The multi-band antenna of any of Clauses 1-3, wherein the high band radiation portion comprises a plurality of arms of different lengths coupled to a base of the upright low band radiation portion.
Clause 8. A multi-band antenna, comprising: a feeding portion; a grounding portion; a first low band radiation portion; a second low band radiation portion coupled to the first low band radiation portion; a third low band radiation portion coupled to the second low band radiation portion; a fourth low band radiation portion coupled to the second low band radiation portion and not contacting the third low band radiation portion; and a high band radiation portion.
Clause 9. The multi-band antenna of Clause 8, wherein the second low band radiation portion is not-coplanar with the first low band radiation portion.
Clause 10. The multi-band antenna of Clause 8, wherein the second low band radiation portion is coplanar with the first low band radiation portion.
Clause 11. The multi-band antenna of any of Clauses 8-10, wherein the high band radiation portion comprises two arms coupled to a base of the first low band radiation portion.
Clause 12. The multi-band antenna of any of Clauses 8-10, wherein the high band radiation portion comprises a single arm coupled to a base of the first low band radiation portion.
Clause 13. The multi-band antenna of any of Clauses 8-10, wherein the high band radiation portion comprises a plurality of arms coupled to a base of the first low band radiation portion.
Clause 14. The multi-band antenna of any of Clauses 8-10, wherein the high band radiation portion comprises a plurality of arms of different lengths coupled to a base of the first low band radiation portion.
Clause 15. The multi-band antenna of any of Clauses 8-14, wherein the third low band radiation portion has a first dimension, wherein the fourth low band radiation portion has a second dimension, and wherein the first dimension and the second dimension are substantially the same.
Clause 16. The multi-band antenna of any of Clauses 8-14, wherein the third low band radiation portion has a first dimension, wherein the fourth low band radiation portion has a second dimension, and wherein the first dimension and the second dimension are different.
Clause 17. A multi-band antenna system, comprising: a base; a ground reference portion coupled to the base; a cover, the cover configured to be removably coupled to the base; four low/high multi-band antenna devices; four multi-band WiFi antenna devices; and a GPS radiating device; wherein the four low/high multi-band antenna devices, the four multi-band WiFi antenna devices, and the GPS radiating device are coupled to the ground reference portion and positioned between the base and the cover.
Clause 18. The multi-band antenna system of Clause 17, wherein at least one of the four low/high multi-band antenna devices comprises: a feeding portion; a grounding portion; an upright low band radiation portion; a second low band radiation portion; and a high band radiation portion that is constructed of two arms that are attached to a base of the upright low band radiation portion.
Clause 19. The multi-band antenna system of Clause 17 or Clause 18, wherein the ground reference portion comprises eight coaxial inputs coupled to eight microstrip transmission lines embedded in the ground reference portion, wherein each microstrip transmission line of the eight microstrip transmission lines extends to one of the four low/high multi-band antenna devices or one of the four multi-band WiFi antenna devices.
Clause 20. The multi-band antenna system of any of Clauses 17-19, further comprising a plurality coaxial connectors, wherein the ground reference portion comprises one or more reliefs positioned near the eight coaxial inputs, the one or more reliefs configured such that a conduction of heat during a soldering process of the plurality of coaxial connectors is inhibited.
Clause 21. A multi-band antenna system, comprising: a base; a ground reference portion coupled to the base; a cover, the cover configured to be removably coupled to the base; two low/high multi-band antenna devices; three multi-band WiFi antenna devices; and a GPS radiating device; wherein the two low/high multi-band antenna devices, the three multi-band WiFi antenna devices, and the GPS radiating device are coupled to the ground reference portion and positioned between the base and the cover.
Clause 22. The multi-band antenna system of Clause 21, wherein at least one of the two low/high multi-band antenna devices comprises: a feeding portion; a grounding portion; an upright low band radiation portion; a second low band radiation portion; and a high band radiation portion that is constructed of two arms that are attached to a base of the upright low band radiation portion.
Clause 23. The multi-band antenna system of Clause 21 or Clause 22, wherein the ground reference portion comprises five coaxial inputs coupled to five microstrip transmission lines embedded in the ground reference portion, wherein each microstrip transmission line of the five microstrip transmission lines extends to one of the two low/high multi-band antenna devices or one of the three multi-band WiFi antenna devices.
Clause 24. The multi-band antenna system of any of Clauses 21-23, further comprising a plurality coaxial connectors, wherein the ground reference portion comprises one or more reliefs positioned near the five coaxial inputs, the one or more reliefs configured such that a conduction of heat during a soldering process of the plurality of coaxial connectors is inhibited.
Clause 25. A multi-band antenna, comprising: a feeding portion; a grounding portion; an upright low band radiation portion; a second low band radiation portion; and a high band radiation portion that is constructed of two arms coupled to a base of the upright low band radiation portion.
Clause 26. The multi-band antenna of clause 26, where in the upright low band radiation portion has a second portion that is coplanar to the first portion and a high band radiation portion that is constructed of two arms that attached to the base of the upright low band radiation portion.
Clause 27. The multi-band antenna of clause 26, where in the upright low band radiation portion has a second portion that is coplanar to the first portion and a high band radiation portion that is constructed of a single arm that attached to the base of the upright low band radiation portion.
Clause 28. The multi-band antenna of clause 26, where in the upright low band radiation portion has a second portion that is not-coplanar to the first portion and a high band radiation portion that is constructed of a two arms that attached to the base of the upright low band radiation portion.
Clause 29. The multi-band antenna of clause 26, where in the upright low band radiation portion has a second portion that is not-coplanar to the first portion and a high band radiation portion that is constructed of a single arm that attached to the base of the upright low band radiation portion.
Clause 30. The multi-band antenna of clause 26, where in the upright low band radiation portion has a second portion that is coplanar to the first portion and a high band radiation portion that is constructed of a plurality of arms that attached to the base of the upright low band radiation portion.
Clause 31. The multi-band antenna of clause 26, where in the upright low band radiation portion has a second portion that is not-coplanar to the first portion and a high band radiation portion that is constructed of a plurality of arms that attached to the base of the upright low band radiation portion.
Clause 32. The multi-band antenna of clause 26, where in the upright low band radiation portion has a second portion that is coplanar to the first portion and a high band radiation portion that is constructed of a plurality of arms of different lengths that attached to the base of the upright low band radiation portion.
Clause 33. The multi-band antenna of clause 26, where in the upright low band radiation portion has a second portion that is not-coplanar to the first portion and a high band radiation portion that is constructed of a plurality of arms of different lengths that attached to the base of the upright low band radiation portion.
Clause 34. A multi-band antenna, comprising: a feeding portion; a grounding portion; an upright low band radiation portion; a second low band radiation portion; a third low band radiation portion of one length coupled to the second low band radiation portion; and a high band radiation portion that is constructed of two arms that attached to the base of the upright low band radiation portion.
Clause 35. The multi-band antenna of clause 34, where in the upright low band radiation portion has a second portion that is coplanar to the first portion and a high band radiation portion that is constructed of two arms that attached to the base of the upright low band radiation portion.
Clause 36. The multi-band antenna of clause 34, where in the upright low band radiation portion has a second portion that is coplanar to the first portion and a high band radiation portion that is constructed of a single arm that attached to the base of the upright low band radiation portion.
Clause 37. The multi-band antenna of clause 34, where in the upright low band radiation portion has a second portion that is not-coplanar to the first portion and a high band radiation portion that is constructed of a two arms that attached to the base of the upright low band radiation portion.
Clause 38. The multi-band antenna of clause 34, where in the upright low band radiation portion has a second portion that is not-coplanar to the first portion and a high band radiation portion that is constructed of a single arm that attached to the base of the upright low band radiation portion.
Clause 39. The multi-band antenna of clause 34, where in the upright low band radiation portion has a second portion that is coplanar to the first portion and a high band radiation portion that is constructed of a plurality of arms that attached to the base of the upright low band radiation portion.
Clause 40. The multi-band antenna of clause 34, where in the upright low band radiation portion has a second portion that is not-coplanar to the first portion and a high band radiation portion that is constructed of a plurality of arms that attached to the base of the upright low band radiation portion.
Clause 41. The multi-band antenna of clause 34, where in the upright low band radiation portion has a second portion that is coplanar to the first portion and a high band radiation portion that is constructed of a plurality of arms of different lengths that attached to the base of the upright low band radiation portion.
Clause 42. The multi-band antenna of clause 34, where in the upright low band radiation portion has a second portion that is not-coplanar to the first portion and a high band radiation portion that is constructed of a plurality of arms of different lengths that attached to the base of the upright low band radiation portion.
Clause 43. A multi-band antenna, comprising: a feeding portion; a grounding portion; an upright low band radiation portion; a second low band radiation portion; a third low band radiation portion of one length coupled to the second low band radiation portion; a fourth low band radiation portion of a length different to the third low band radiation portion while coupled to the second low band radiation portion while also coupled to the third low band radiation portion; and a high band radiation portion that is constructed of two arms that attached to the base of the upright low band radiation portion.
Clause 44. The multi-band antenna of clause 43, where in the upright low band radiation portion has a second portion that is coplanar to the first portion and a high band radiation portion that is constructed of two arms that attached to the base of the upright low band radiation portion.
Clause 45. The multi-band antenna of clause 43, where in the upright low band radiation portion has a second portion that is coplanar to the first portion and a high band radiation portion that is constructed of a single arm that attached to the base of the upright low band radiation portion.
Clause 46. The multi-band antenna of clause 43, where in the upright low band radiation portion has a second portion that is not-coplanar to the first portion and a high band radiation portion that is constructed of a two arms that attached to the base of the upright low band radiation portion.
Clause 47. The multi-band antenna of clause 43, where in the upright low band radiation portion has a second portion that is not-coplanar to the first portion and a high band radiation portion that is constructed of a single arm that attached to the base of the upright low band radiation portion.
Clause 48. The multi-band antenna of clause 43, where in the upright low band radiation portion has a second portion that is coplanar to the first portion and a high band radiation portion that is constructed of a plurality of arms that attached to the base of the upright low band radiation portion.
Clause 49. The multi-band antenna of clause 43, where in the upright low band radiation portion has a second portion that is not-coplanar to the first portion and a high band radiation portion that is constructed of a plurality of arms that attached to the base of the upright low band radiation portion.
Clause 50. The multi-band antenna of clause 43, where in the upright low band radiation portion has a second portion that is coplanar to the first portion and a high band radiation portion that is constructed of a plurality of arms of different lengths that attached to the base of the upright low band radiation portion.
Clause 51. The multi-band antenna of clause 43, where in the upright low band radiation portion has a second portion that is not-coplanar to the first portion and a high band radiation portion that is constructed of a plurality of arms of different lengths that attached to the base of the upright low band radiation portion.

### ADDITIONAL CONSIDERATIONS AND TERMINOLOGY

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations, and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

1.-51. (canceled)

52. An antenna system, comprising:
a base;
a cover, the cover configured to be removably coupled to the base;
a ground reference portion coupled to the base and positioned between the base and the cover;
a first multi-band antenna coupled to the ground reference portion, the first multi-band antenna comprising a first low band radiation portion facing in a first direction; and
a second multi-band antenna coupled to the ground reference portion, the second multi-band antenna comprising a second low band radiation portion facing in a second direction, the second direction substantially opposite the first direction.

53. The antenna system of claim 52, wherein the first multi-band antenna comprises a first feeding portion, a first grounding portion, and a first high band radiation portion, wherein the second multi-band antenna comprises a second feeding portion, a second grounding portion, and a second high band radiation portion.

54. The antenna system of claim 53, wherein the first high band radiation portion comprises two arms coupled to a base of the first low band radiation portion.

55. The antenna system of claim 53, wherein the first high band radiation portion comprises a single arm coupled to a base of the first low band radiation portion.

56. The antenna system of claim 53, wherein the first high band radiation portion comprises a plurality of arms coupled to a base of the first low band radiation portion.

57. The antenna system of claim 53, wherein the first high band radiation portion comprises a plurality of arms of different lengths coupled to a base of the first low band radiation portion.

58. The antenna system of claim 53, wherein the first multi-band antenna comprises a first top low band radiation portion, the first top low band radiation portion being coplanar with the first low band radiation portion.

59. The antenna system of claim 53, wherein the first multi-band antenna comprises a first top low band radiation portion, the first top low band radiation portion being not-coplanar with the first low band radiation portion.

60. The antenna system of claim 59, wherein the first low band radiation portion is formed on a first lower substrate and the first top low band radiation portion is formed on a top substrate, the top substrate at least partially supported by the first lower substrate.

61. The antenna system of claim 60, wherein the first lower substrate comprises one or more top projections, the one or more top projections configured to extend through one or more corresponding slots in the top substrate.

62. The antenna system of claim 60, wherein the second multi-band antenna comprises a second top low band radiation portion, wherein the second low band radiation portion is formed on a second lower substrate and the second top low band radiation portion is formed on the top substrate, the top substrate at least partially supported by the second lower substrate.

63. The antenna system of claim 62, wherein the first top low band radiation portion and the second top low band radiation portion both face in a third direction, the third direction substantially perpendicular to the first direction and the second direction.

64. The antenna system of claim 52, wherein the ground reference portion comprises a plurality of coaxial inputs coupled to a plurality of microstrip transmission lines embedded in the ground reference portion, wherein a first microstrip transmission line of the plurality of microstrip transmission lines extends to the first multi-band antenna and a second microstrip transmission line of the plurality of microstrip transmission lines extends to the second multi-band antenna.

65. The antenna system of claim 64, further comprising a plurality of coaxial connectors, wherein the ground reference portion comprises one or more reliefs positioned near the plurality of coaxial inputs, the one or more reliefs configured such that a conduction of heat during a soldering process of the plurality of coaxial connectors is inhibited.

66. The antenna system of claim 64, further comprising one or more multi-band WiFi antennas, wherein each of the one or more multi-band WiFi antennas are electrically coupled to at least one of the plurality of microstrip transmission lines.

67. The antenna system of claim 64, further comprising a GPS radiating devices electrically coupled to at least one of the plurality of microstrip transmission lines.

68. The antenna system of claim 52, further comprising a third multi-band antenna and a fourth multi-band antenna coupled to the ground reference portion, the third multi-band antenna comprising a third low band radiation portion facing in the first direction and the fourth multi-band antenna comprising a fourth low band radiation portion facing in the second direction.

69. The antenna system of claim 68, wherein the third multi-band antenna and the fourth multi-band antenna are substantially longitudinally aligned with the first multi-band antenna and the second multi-band antenna.

70. The antenna system of claim 60, wherein the first grounding portion is formed on a first grounding substrate comprising one or more side projections, the one or more side projections configured to extend through one or more corresponding plated slots in the first lower substrate.

71. The antenna system of claim 70, wherein the one or more plated slots and the one or more side projections are configured to provide a mechanical connection between the first grounding substrate and the first lower substrate and an electrical connection between the first grounding portion and the first multi-band antenna.
